(19) United States
(12) Patent Application Publication
(10) Pub. No.: US 2010/0325844 A1
(43) Pub. Date: Dec. 30, 2010

(54) Magnetomechanical Connection Assembly with Load Securing

(75) Inventor: Joachim Fiedler, Hannover (DE)

Correspondence Address: THE WEBB LAW FIRM, P.C., 700 KOPPERS BUILDING, 436 SEVENTH AVENUE, PITTSBURGH, PA, 15219, US

(73) Assignee: FIDLOCK GMBH, Hannover (DE)

(21) Appl. No.: 12/918,440

(22) PCT Filed: Feb. 22, 2009
(86) PCT No.: PCT/DE09/00231

§ 371 Date: Aug. 19, 2010

(30) Foreign Application Priority Data
Feb. 21, 2008 (DE) 10 2008 010 273.3

(51) Int. Cl. H01F 7/02

(52) U.S. Cl. 24/303

(57) ABSTRACT

The invention relates to a connection assembly, comprising two connecting modules each with a load housing with a locking device with a spring locking element and a latch piece, a magnet and armature construction and a movement track, on which the latch piece can be moved from a closed position to an open position, the locking device, the magnet and armature construction and the movement track cooperating by means of an opening, the connecting modules are moved on the movement track, wherein the magnet and armature are moved in opposition and the latch piece and the spring locking element are moved in opposition, until the spring locking element is no longer engaged. On closing, the connecting module locks in with the aid of magnetic force. The position of the load housing and the position and form of the movement track are designed such that on moving the connecting module the loading housings move together by an amount Δx against the load FL.

This invention relates to a magnetomechanical connection assembly, i.e. a connection assembly with mechanical locking by means of magnetic-force assistance, with this connection assembly being particularly useful for closures as they are used on bags, rucksacks and comparable objects. However, this enumeration is not limiting for the field of application of the invention.

These hand-actuated closures must satisfy a wide variety of requirements depending on their application.

For example, it is a requirement that the closure is self-blocking under load. To satisfy this requirement, such closures include undercuts or bevels and are constructed such that a positive locking is obtained when the closure is loaded in the intended loading direction. For closing the closure, the closure halves to be connected are moved towards each other in closing direction and then mostly are hung into each other.

The explanations given below relate to closure halves which should be closed and are under a pretension, i.e. a force is applied to the closure halves which acts opposite to the closing direction.

For being hung into each other, the closure halves are moved into a closed position in which they are moved towards each other over a hang-in point. While being hung into each other, the closure halves move a smaller or larger distance opposite to the pretension, depending on the depth of the undercut. For opening, these closure halves must again be moved this distance opposite to the pretension, in order to disengage the closure halves, i.e. to overcome the undercut. Under pretension, the closure halves thus are harder to separate than without pretension. When disengaging or hanging out the closure halves, it often is also necessary to slightly move the closure halves sideways. These movements normally are not registered by man, because the human hand can easily perform such movements. When the performance of the hand is restricted, however, e.g. due to an illness, or when a ski glove is worn, the movements taking place on opening and closing gain great importance, in particular when on closing a force acts on at least one closure half, against which the force of the human hand must work.

The requirement that the closure can not or only hardly be opened under load thus has been fulfilled by means of the above-described locking with the undercuts, but only at the price that under pretension the closure closes just as hard as it opens.

However, there is also the requirement according to which it should be possible to comfortably close the closure under load. This can for example be achieved in that e.g. a push-in buckle also contains a magnet-armature construction beside the mechanical locking. In this way, it is achieved that the closure halves are pulled together on their own and thus the hand force is supported by the magnetic force of attraction.

Such closures often can only be opened again with a jerk, because on opening the magnetic force must be overcome. In a number of applications it is, however, desired that the closure can also be opened very easily and comfortably, so that even persons who wear thick gloves or are restricted in their manual motoricity can easily open the closure when the closure is unloaded.

From the prior art, a variety of closure constructions are known which, however, always satisfy only part of the above-described requirements.

For example, the documents WO2008/006357 A2 and WO2009/010049 A2 describe two closure constructions which are very easy to close and to open, but do not offer safe locking under load. Accordingly, such closure can open inadvertently under load, which must be avoided in the case of safety-relevant requirements. In these two closure constructions, closing is achieved or supported with the aid of magnetic force.

In the document EP 97 921 465, a closure construction for jewelry is described, in which the load occurring in use likewise is absorbed by means of a positive mechanical connection. Furthermore, magnets are provided, which effect a certain aid on closing. This magnetic closure opens harder under load than without load, since as described above the closure halves are hung into each other and for hanging out must be moved a certain distance towards each other. However, on closing under load it will close just as hard, since it must be moved against the load by the depth of the undercut. In addition, it is in part also necessary to work against the magnetic force. Depending on the constructive design of such magnetic closures, a more or less jerky separation of the magnet from the armature is obtained, which impairs the opening haptics of the closure.

From the spectrum of the different requirement profiles of the opening and closing behavior of closures which are opened and closed by hand, the following profile or requirements has not yet become known from the prior art:
automatic or very easy closing without load
closing-force assistance on closing under load
safe locking under load
very easy opening without load

It is the object of the invention to provide a closure which satisfies the requirement profile described above.

This object is solved with the closure constructions of the invention according to claims 1 and 2.

According to claim 1, a magnetomechanical connection assembly includes two connecting modules for connecting two elements. To each of the elements one of the connecting modules can be attached. Attachment is effected to the load housing of the connecting module. The load housing in a push-in buckle, for example, are the slot-shaped openings into which the belt webbings are threaded, in order to fasten the belt webbings at the push-in buckle. On closing, the connecting modules can already be loaded with a load F_{L}, i.e. the connecting modules must e.g. be pulled together by hand against the force generated by the load, before they come into engagement and are locked.

The force direction of the load F_{L} extends substantially in direction of the connecting line between the load housings, i.e. in a push-in buckle arrangement the force direction extends on a line in direction of two tensioned belt webbings, whose end portions are connected with each other by means of the push-in buckle.

The connecting modules have the following features: a locking device for positively locking the connecting modules, wherein the locking device includes a spring locking element which is arranged in the first connecting module. In the second connecting module a matching locking piece is arranged.

A magnet-armature construction is provided, comprising a magnet which is arranged in one of the connecting modules and an armature or a second magnet which is arranged in the other connecting module.

Furthermore, a movement track is formed in the first connecting module, on which the locking piece of the second connecting module can be shifted from a closed position, i.e. a locking condition, into an open position, i.e. into an unlocked condition.

The locking device, the magnet-armature construction and the movement track are operatively connected by the following features:

On opening, the connecting modules are shifted on the movement track from the closed position into the open position, wherein the magnet and the armature or the second magnet are shifted against each other, so that a gradual attenuation of the mutual magnetic attraction occurs.

At the same time, the locking piece and the spring locking element are shifted against each other on the movement track, until the spring locking element enters into an especially provided recess in the locking piece and thus no longer is in engagement with the locking piece.

On closing, the connecting modules directly lock into the closed position by means of the locking device, in contrast to the subject-matter of EP 97 921 465, wherein the locking piece pushes the spring locking element to the side, until it snaps into place.

On closing, the magnet-armature construction at the same time pulls the connecting modules towards each other, whereby the locking of the locking device is at least supported.

In accordance with the invention, the spatial position of the load housings on the connecting modules and the spatial position and shape of the movement track are formed and chosen such that on shifting the connecting modules from the closed position into the open position the load housings of the connecting modules must move onto each other by an amount Δx. This opening movement is effected against the load F_{L}, so that a physical work W=F_{L}×Δx is necessary for this purpose. Thus, the connection assembly is harder to open under the load F_{L} than without the load F_{L}.

Thus, the object of the invention has been solved. The connection assembly closes automatically or very easily without load, since the magnetic force strongly supports the closing movement. Furthermore, the connection assembly will even comfortably close under load due to the magnetic closing-force assistance. Under load, a very safe locking is effected, which is the greater the greater the force of the acting load becomes. And without load, the connection assembly can be opened very easily.

According to claim 2, a magnetomechanical connection assembly includes two connecting modules for connecting two elements. To each of the elements one of the connecting modules can be attached. Attachment is effected to the load housing of the connecting module. The load housing of a push-in buckle are the slot-shaped openings into which the belt webbings are threaded, in order to fasten the belt webbings at the push-in buckle. On closing, the connecting modules can already be loaded with a load F_{L}, i.e. the connecting modules must e.g. be pulled together by hand against the force generated by the load, before they come into engagement and are locked.

The force direction of the load F_{L} extends substantially in direction of the connecting line between the load housings, i.e. in a push-in buckle arrangement the force direction extends on a line in direction of two tensioned belt webbings, whose end portions are connected with each other by means of the push-in buckle.

The connecting modules have the following features: a locking device for positively locking the connecting modules, wherein the locking device includes a spring locking element which is arranged in the first connecting module. In the second connecting module a matching locking piece is arranged. In addition, a force-deflecting bevel is provided in the second connecting module.

There is provided a magnet-armature construction, comprising a magnet which is arranged in one of the connecting modules and an armature or a second magnet which is arranged in the other connecting module.

Furthermore, a movement track is formed in the first connecting module, on which the locking piece of the second connecting module can be shifted from a closed position, i.e. a locking condition, into an open position, i.e. into an unlocked condition.

The locking device, the magnet-armature construction and the movement track are operatively connected by the following features:

On opening, the connecting modules are shifted on the movement track from the closed position into the open position, wherein the magnet and the armature or the second magnet are shifted against each other, so that a gradual attenuation of the mutual magnetic attraction occurs.

At the same time, the locking piece and the spring locking element are shifted against each other on the movement track, wherein the spring locking element is pushed to the side by the force-deflecting bevel, until the spring locking element no longer is in engagement with the locking piece.

On closing, the connecting modules directly snap into the closed position by means of the locking device, in contrast to the subject-matter of EP 97 921 465, wherein the locking piece pushes the spring locking element to the side, until it snaps into place.

On closing, the magnet-armature construction at the same time pulls the connecting modules towards each other, whereby the locking of the locking device is at least supported.

In accordance with the invention, the spatial position of the load housings on the connecting modules and the spatial position and shape of the movement track are formed and chosen here, as also in claim 1, such that on shifting the connecting modules from the closed position into the open position the load housings of the connecting modules must move onto each other by an amount Δx. This opening movement is effected against the load F_{L}, so that a physical work W=F_{L}×Δx is necessary for this purpose. Thus, the connection assembly is harder to open under the load F_{L} than without the load F_{L}.

To explain the technical teaching underlying the invention, this teaching will first be discussed with reference to abstracted drawings, since this principle is contained in all subsequent concrete closure constructions.

The cooperation of the closure halves on closing and opening of the closure and the corresponding spatial positions of the essential functional elements will be described. Furthermore, the forces acting on closing and opening, i.e. when connecting and separating the closure halves, will be described, and the physical work to be performed on connecting and separating will also be described. For a better understanding, the technical teaching of the invention will be compared with the technical teaching underlying the closure construction of the above-mentioned EP 97 921 465.

The subject-matters of the invention according to claims 1 and 2 merely differ by one feature in the generic part of these claims and relate to the documents WO2008/00637 A2 and WO2009/010049 A2 mentioned as prior art. The difference between the two subject-matters of the invention according to claim 1 and claim 2 is a detail of the opening mechanism of the locking device. For better clarity, the following description of the technical teaching of the invention therefore is only based on the combination of features according to claim 1, since the technical teaching of the invention according to claim 2 is identical to claim 1.

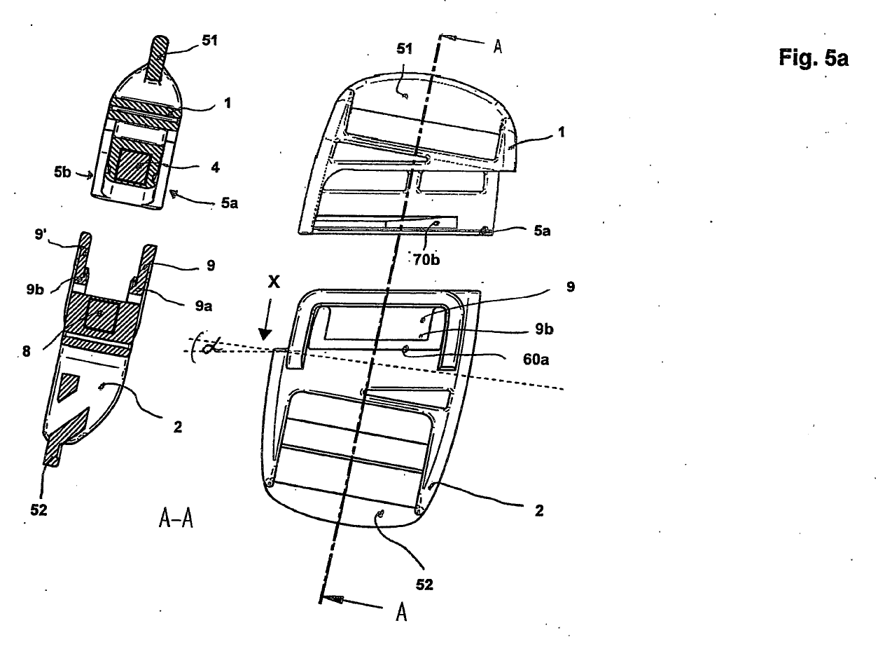

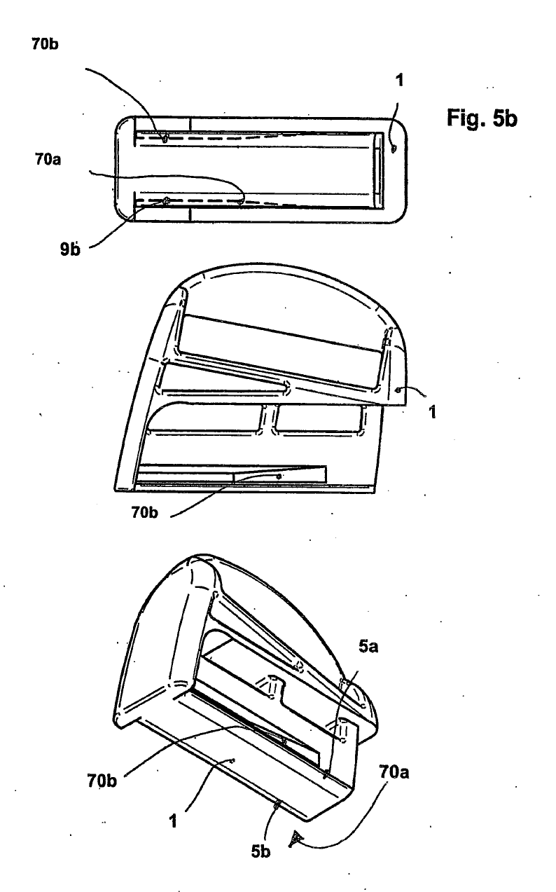

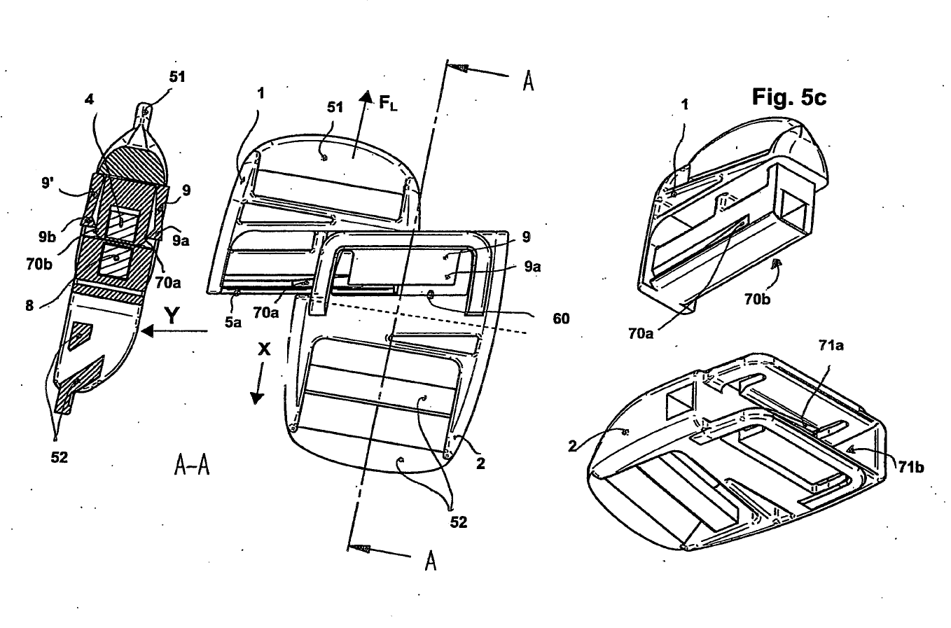

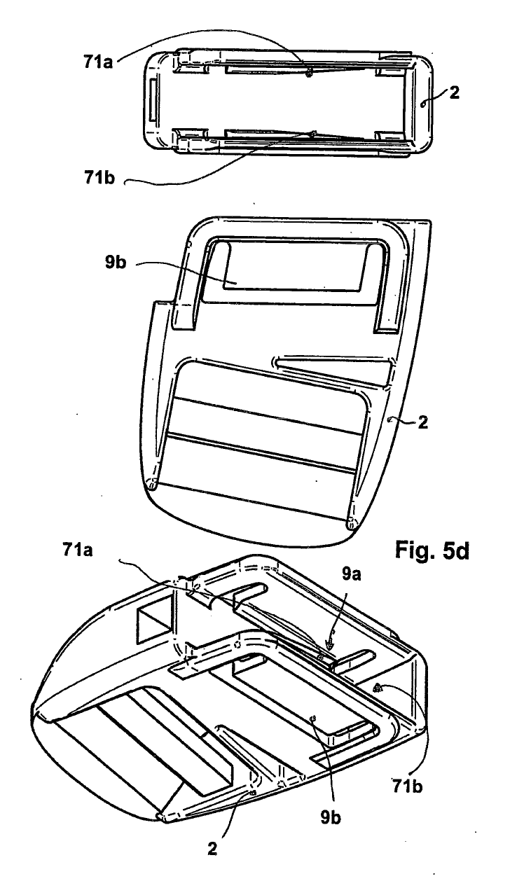

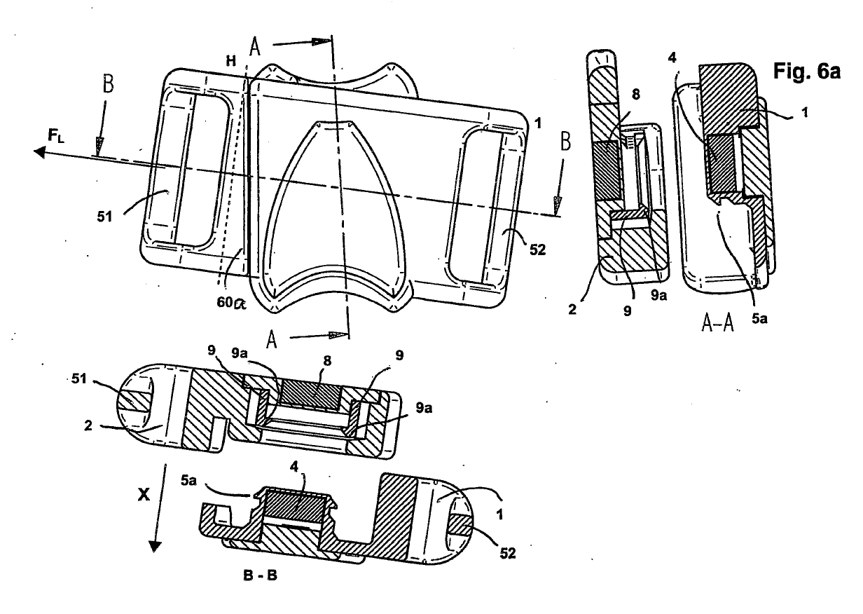

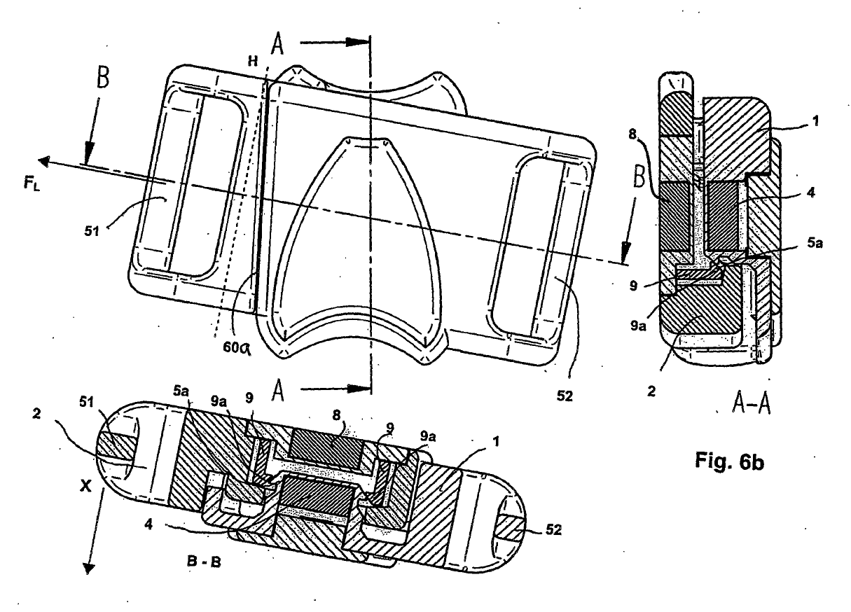

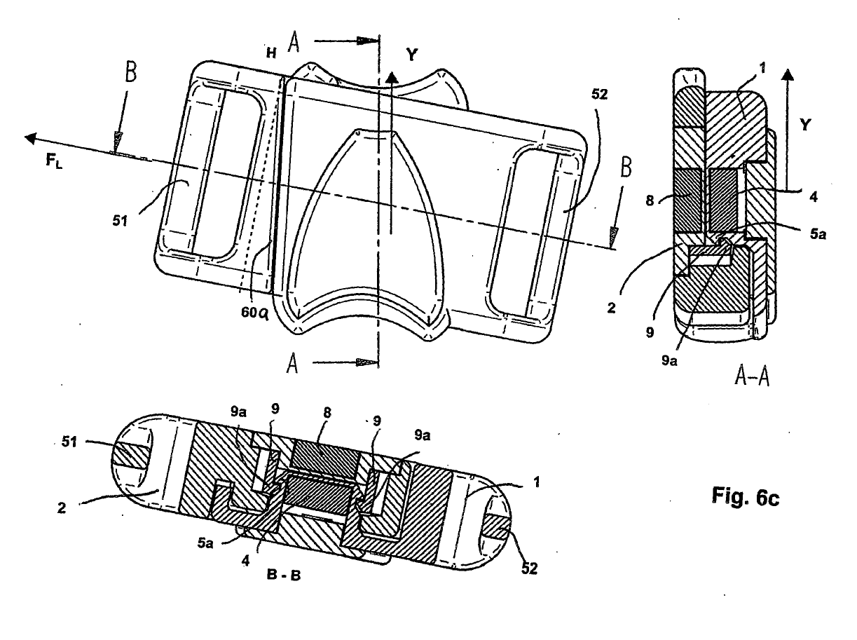

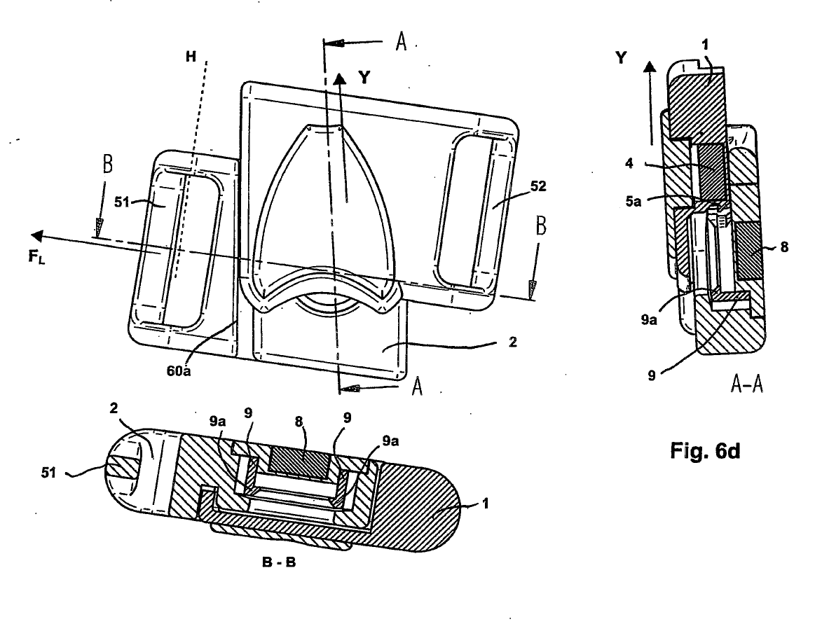

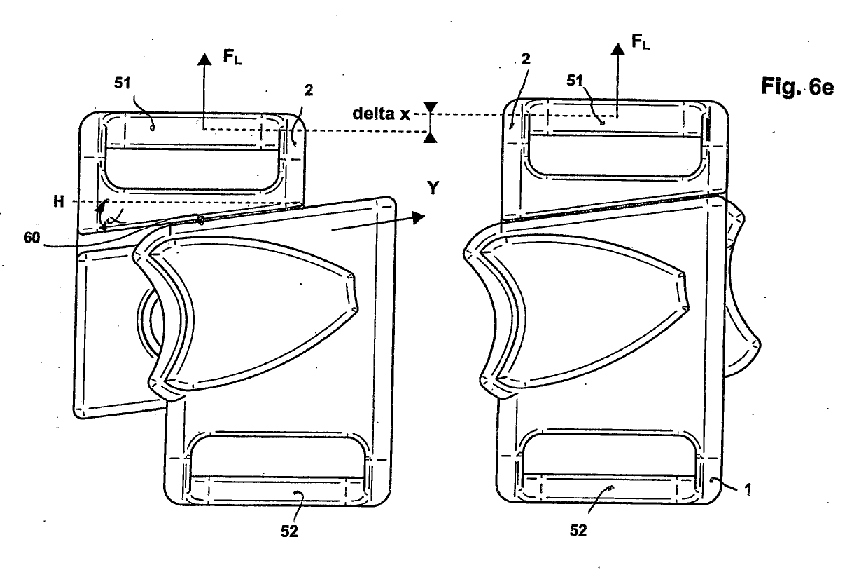

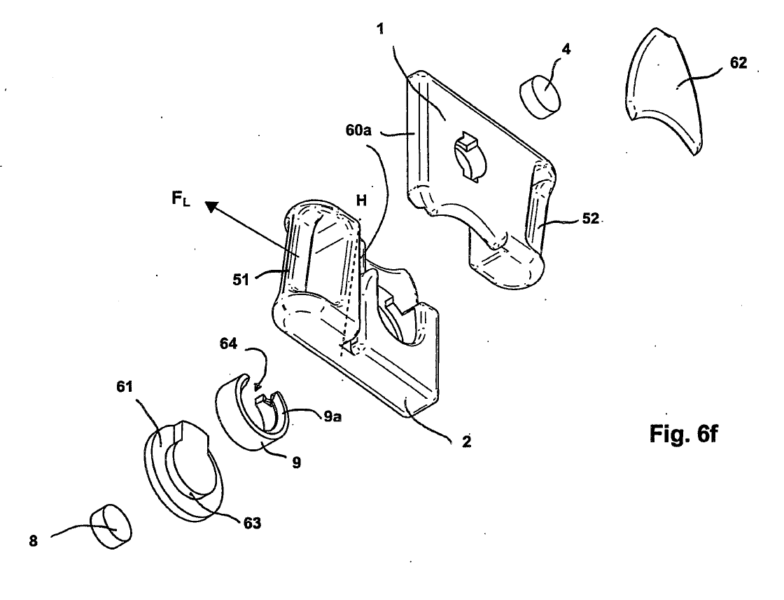

These two different opening mechanisms can be taken from the embodiments with which concrete products are described and shown. The opening mechanism according to claim 2 can be taken from FIG. 5a-e. A combination of the two opening mechanisms can be taken from FIG. 6a-e.

The invention will subsequently be explained in detail with reference to schematic drawings, diagrams and construction drawings.

### LIST OF REFERENCE NUMERALS

1 first connecting module/connecting module 1/plug
2 second connecting module/connecting module 2/housing
4 magnet
5, 5a, 5b locking piece
8 armature or second magnet
9 spring locking element, spring washer
9a, 9b latching nose
38 base
48 magnet
50 offset of magnets
51 load housing, belt webbing receptacle
51a loaded end of belt webbing
52 load housing, belt webbing receptacle
60 movement track
60a, 60a′ inclined movement track
60b, 60b′ movement track curved in the shape of a circular arc
61 end cap
62 decorative cap
63 inner stop
64 opening in spring washer
65 cylinder on plug
66 gap in locking piece
70, 70a, 70b force-deflecting bevel
71a, 71b force-deflecting bevel
74 tongue
80 magnet
98 rigid extension, belt webbing
H horizontal
F_{L} load
X closing direction
Y, Y′ opening direction
Δx displacement of load housing against load (on opening)
Δy displacement of load housing against load (on closing)
W_{Δx} hysical work for displacement Δx
W_{Δy} hysical work for displacement Δy
W_{magI}, W_{mag2}, W_{magnet} physical work from magnetic force
delta M displacement of center
alpha angle of the inclined movement track against H
M center of circular-arc-shaped movement track
R radius of circular-arc-shaped movement track
P₀ closed position, energy level at closed position

The teaching in accordance with the invention will first be explained by comparison with reference to the functions and effects occurring in a magnetic closure according to the prior art as described in document EP 97 921 465.

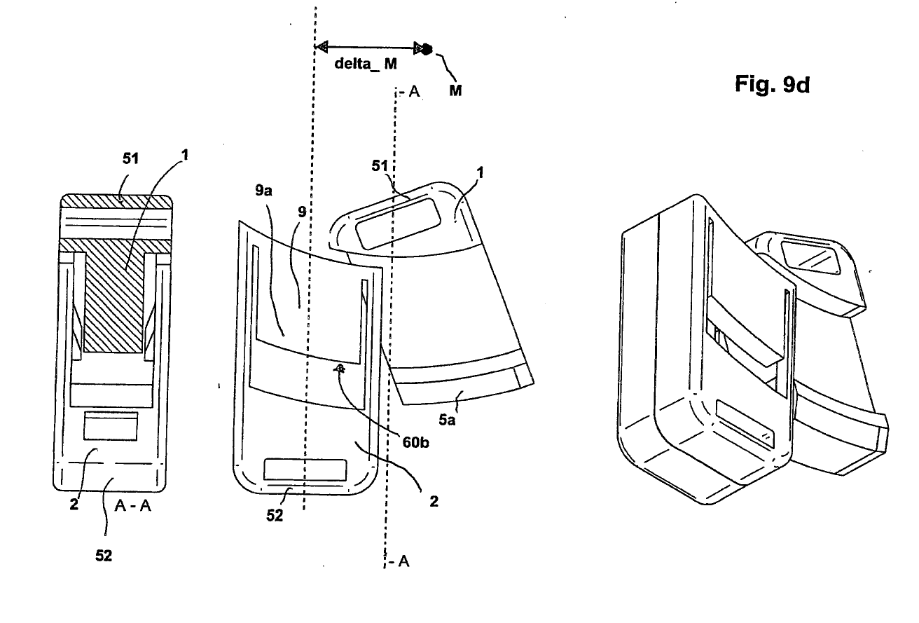

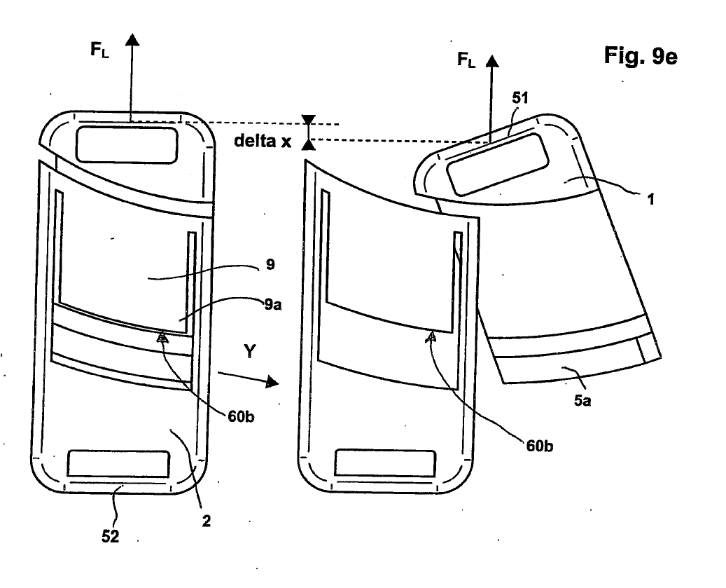

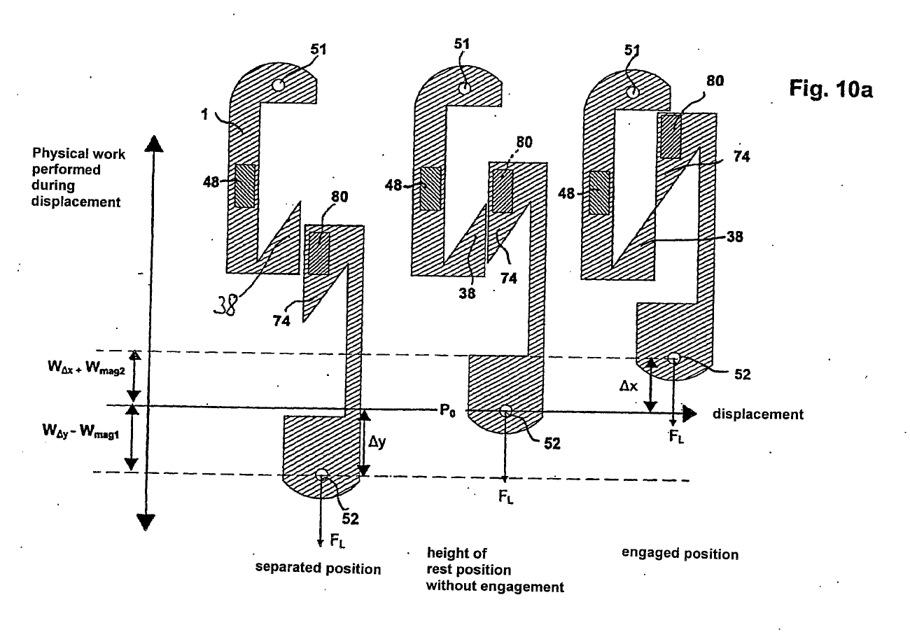

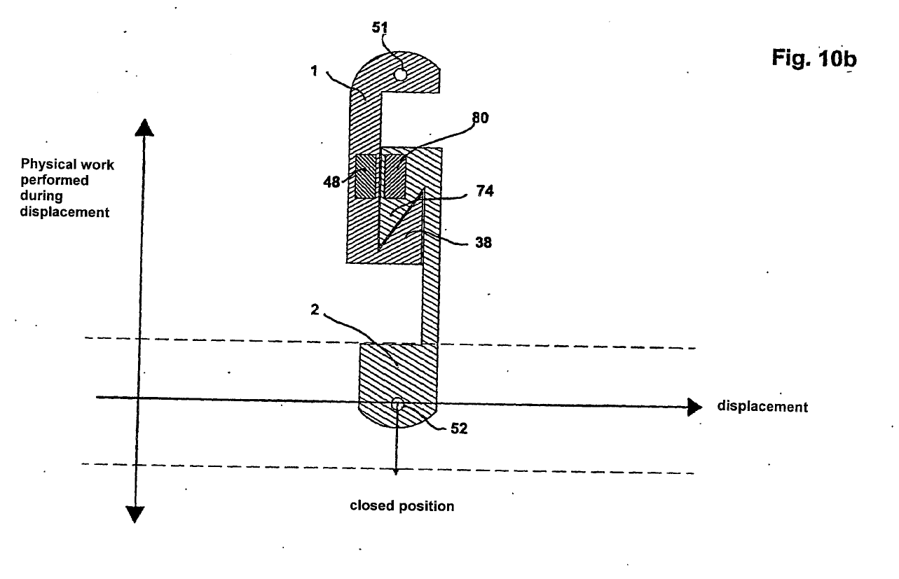

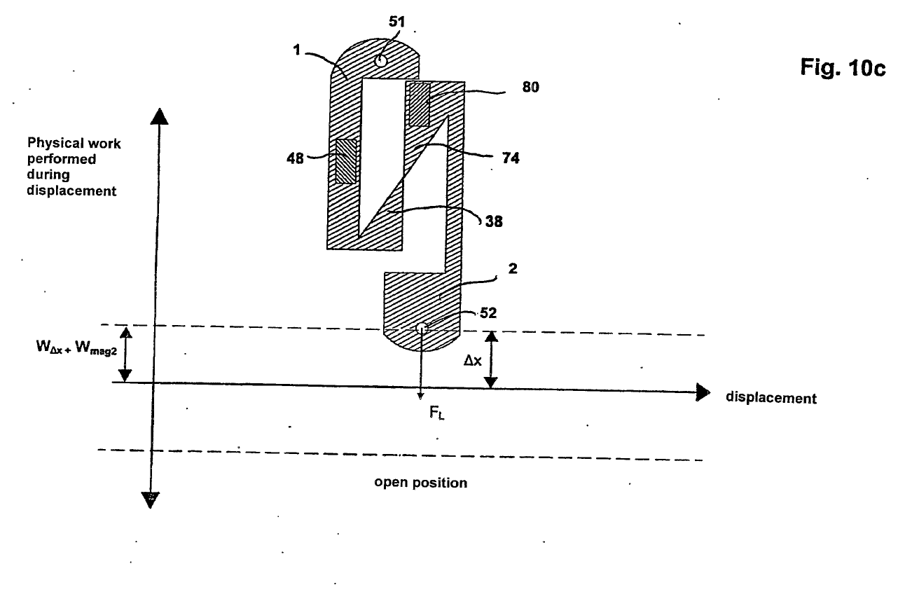

In the form of a diagram, FIGS. 10a to 10c show constructive and also functional features of a hook-shaped closure during closing and opening. In each connecting module 1 and 2, this closure contains one magnet 48 and 80 each and closing means, which are formed as tongue 74 and base 38.

From left to right, FIG. 10a shows in two movement conditions the physical work to be performed on closing of the closure under load.

Proceeding from a rest condition, the connecting module 2 first is lifted against a downwardly directed force F_{L} from a separating position to a height P₀, for which purpose the work W_{Δy} is necessary. The height P₀ is the height position which the connecting module 2 also has in the condition hung in. Since the magnetic force slightly supports such lifting, the actually required work is W_{Δy} minus W_{mag1}, cf. lower double arrow on the left. The force F_{L} is the force which must be overcome on closing under load, in order to hang in the closure.

In the next step of movement, the connecting module 2 is lifted further, so that it is opposed to the recess of the connecting module 1. This distance covered on lifting is designated with Δx. To cover this distance Δx, a work W_{Δx} is necessary. In addition, the magnets having approached each other as far as possible are again moved away from each other. This likewise requires a work which is designated with W_{mag2} and additionally makes closing difficult. It should be noted that closing of this closure is the harder the greater the downwardly directed force F_{L}. Especially in the critical moment of hanging in the connecting module 2, the magnetic force additionally impedes the threading operation.

For completeness, the closed position and the process of opening the closure will also be described.

FIG. 10b shows the closed position of the closure, in which the connecting module 2 is lowered to the height P₀.

FIG. 10c shows the opening of the closure, wherein the connecting module 2 must be lifted by Δx against the load F_{L}.

In contrast to the above-described technical teaching known from the prior art, the closure of the invention closes more comfortably, in particular under load, which will be explained below.

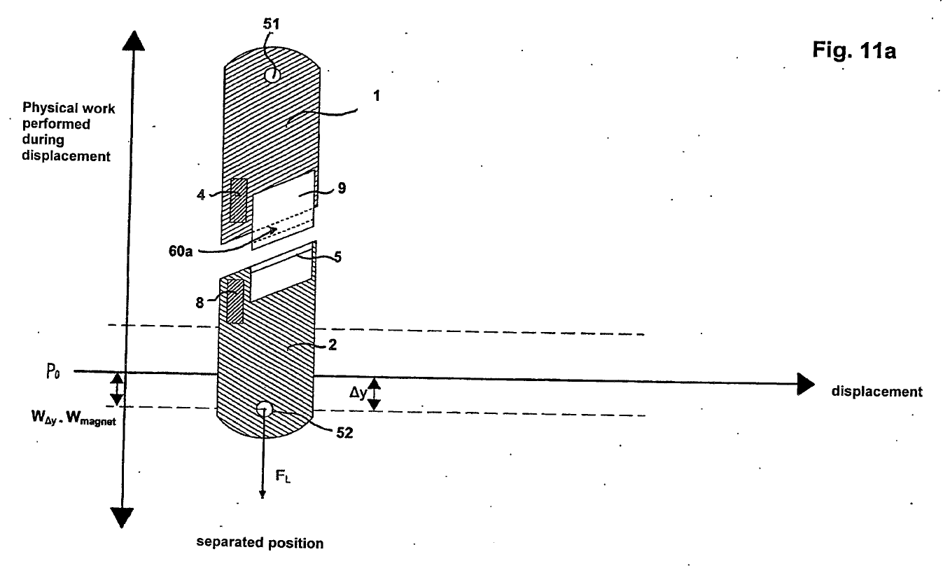

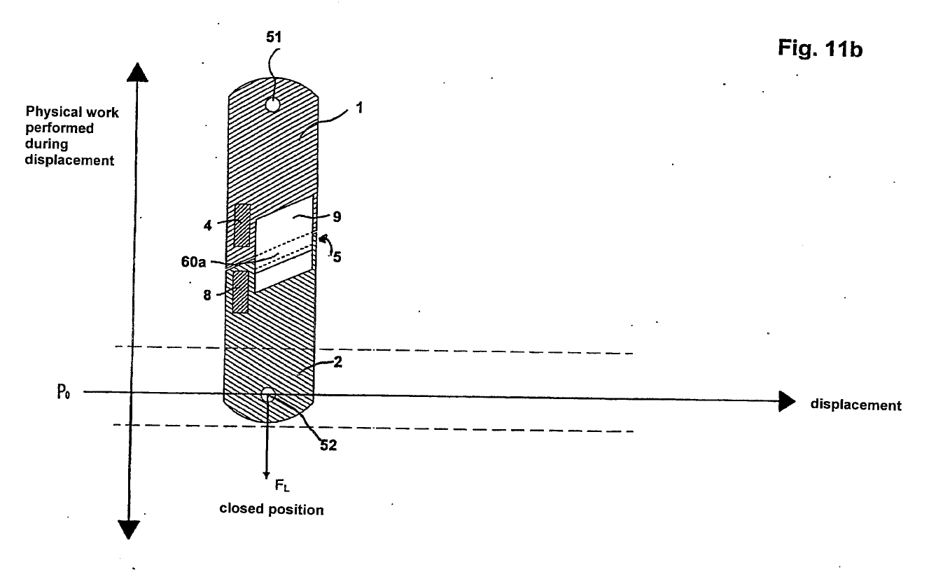

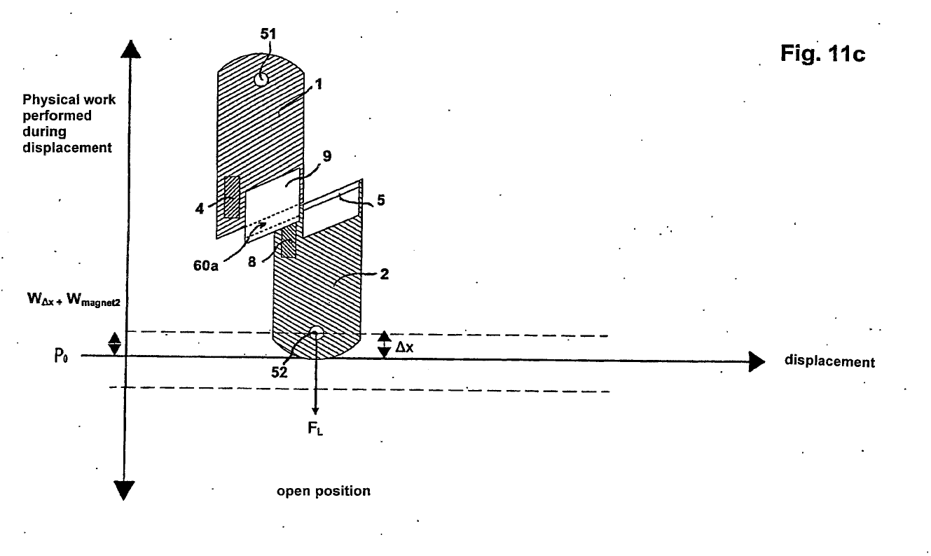

Analogous to FIGS. 10a to 10c, the technical teaching in accordance with the invention will now be explained with reference to FIGS. 11a to 11c. For a better understanding, the difference with respect to the work to be done on closing will be described first.

FIG. 11a shows the work which must be done for closing the closure. The connecting module 2 is in a position in which the magnetic force starts to act. Although the connecting module 2 is pulled downwards by the applied force F_{L}, the magnetic force supports the upward movement of the connecting module 2 against the load F_{L}, until it snaps into the closed position P₀. For this purpose, the work W_{Δy} must be performed. Due to the magnets 4 and 8, the magnetic force between these magnets acts at the same time and performs a work W_{magnet}. Accordingly, the actually required work W_{Δy} is reduced by the work W_{magnet} applied by the magnetic force.

FIG. 11b shows the closure in the closed position P₀, i.e. the connecting modules 1 and 2 have snapped into place, i.e. are latched with each other by means of a spring locking means. The spring locking means consists of a spring locking element 9 and a locking piece 5. When snapping into place, the spring locking element 9 is pushed against the locking piece 5, wherein the spring locking element 9 is pushed to the side, until it snaps into place behind the locking piece 5. Since this spring locking means is known from the above-mentioned prior art, a more detailed description thereof can be omitted.

In contrast to the prior art shown in FIGS. 10a to 10c, the closure of the invention was closed without applying an additional work. In accordance with the object of the invention, this closure accordingly will close comparatively easier and also more comfortably even under load, since merely a linear movement and no complicated hang-in movement is required for snapping into place.

In the following, it will be explained that this closure also solves the object to be hard to open under load.

FIG. 11c shows the opening process. For this purpose, the connecting module 1 and the connecting module 2 are shifted on a movement track 60a, whereby the locking device has come out of engagement. In accordance with the technical teaching of the invention, the position of the load housings 51, 52 and the position and shape of the movement track 60a are chosen such that with this opening displacement of the connecting modules the load housings 51, 52 were moved towards each other by the distance Δx against the force F_{L}, so that a work W_{Δx} had to be performed for this purpose. The required work is the greater the greater the load F_{L}, i.e. the closure opens harder with load than without load.

FIGS. 11a to 11c describe the subject-matter of the invention both according to claim 1 and according to claim 2.

The functionality was shown here with reference to an inclined movement track (60a), but as shown by the following embodiments, the technical teaching of the invention also can be realized by curved tracks.

Subsequently, the developments of the invention according to claims 1 and 2 are set forth in sub-claims 3 to 13.

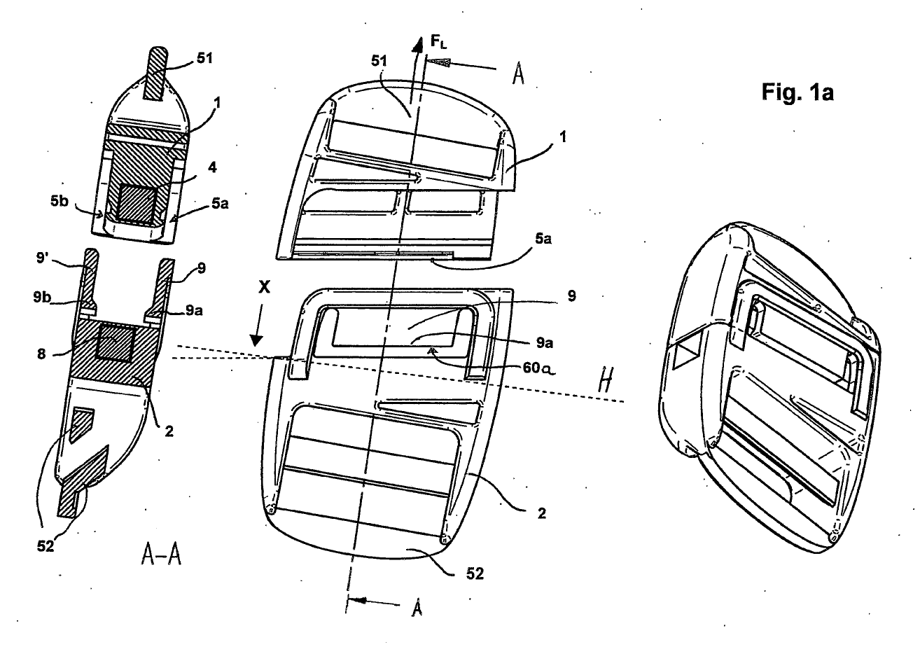

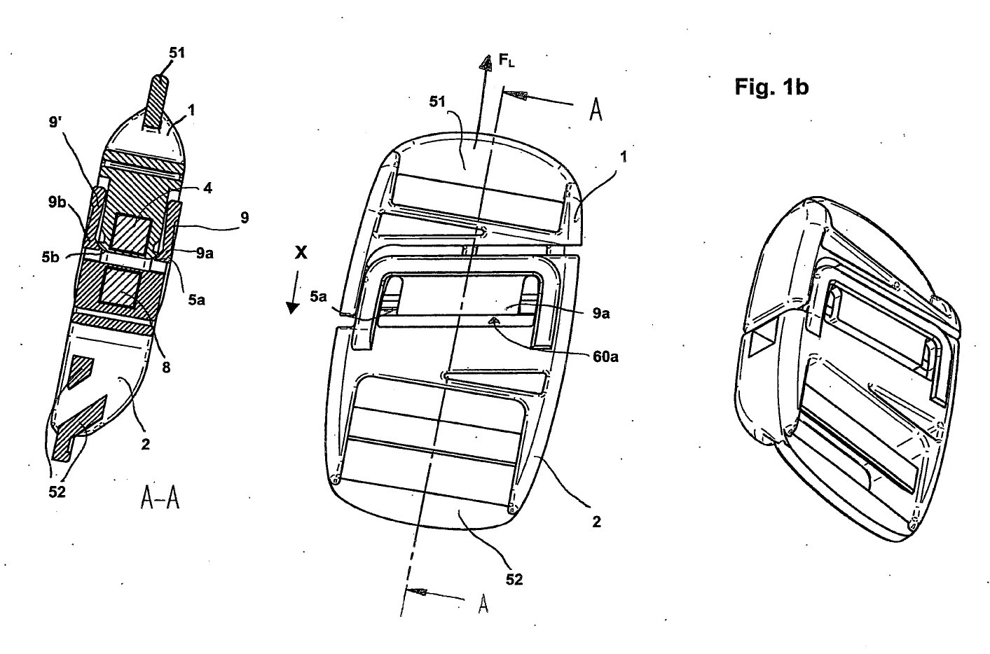

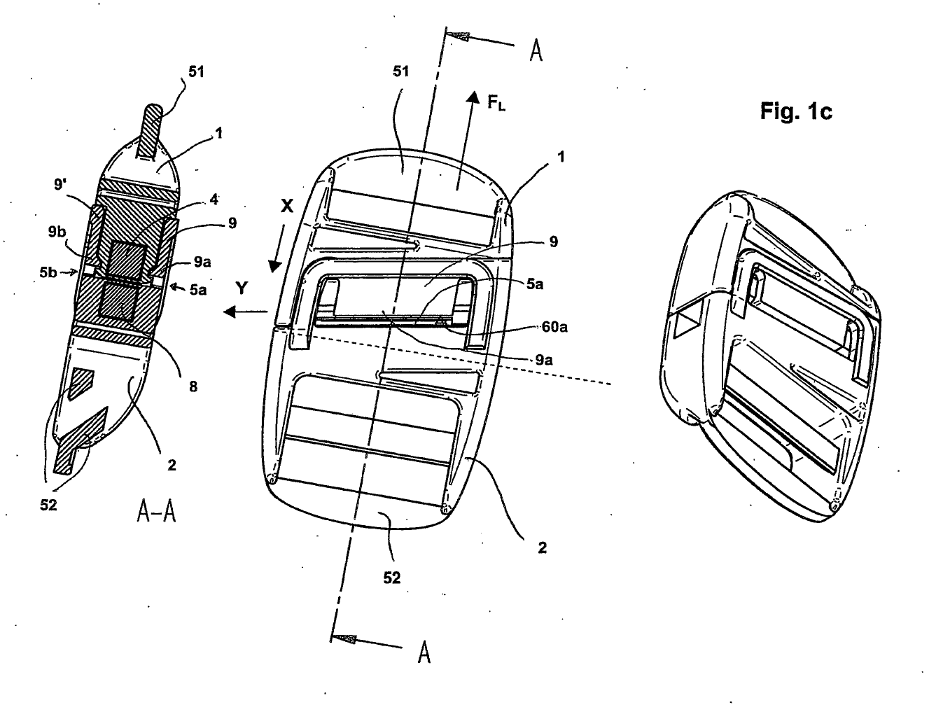

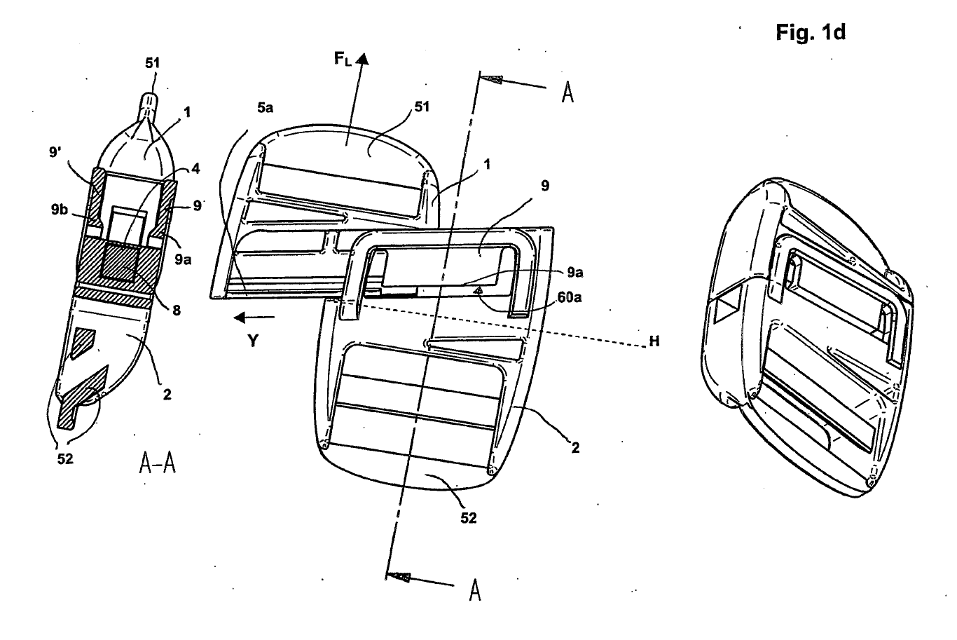

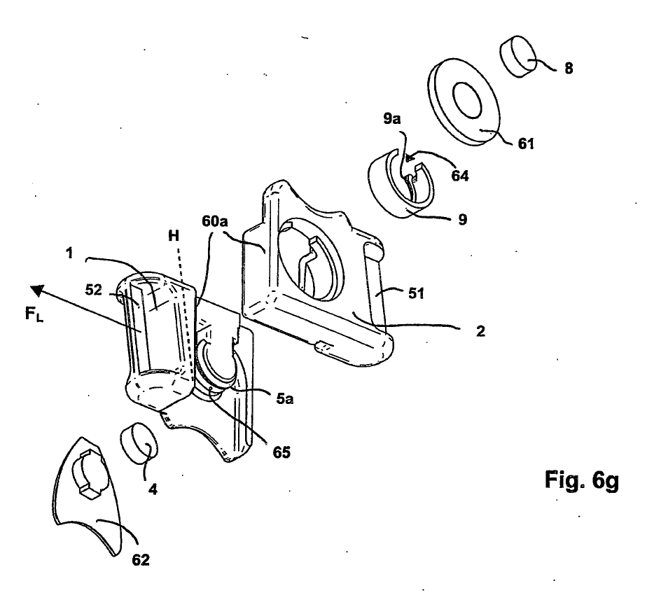

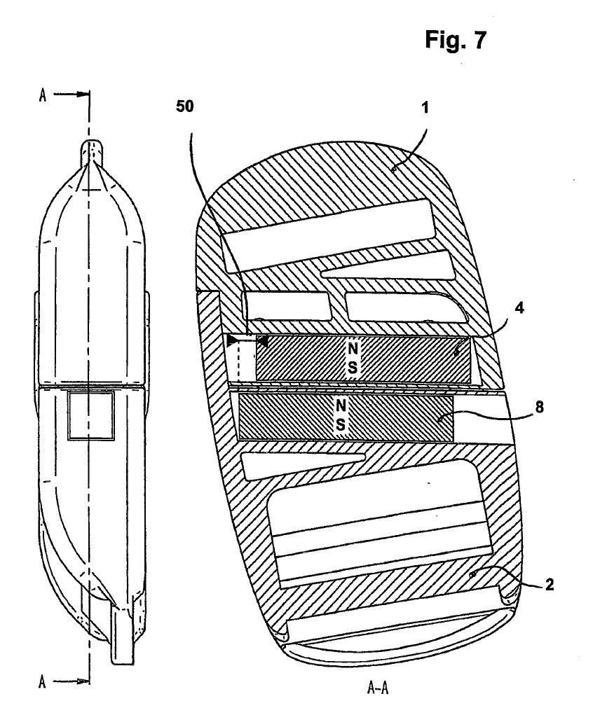

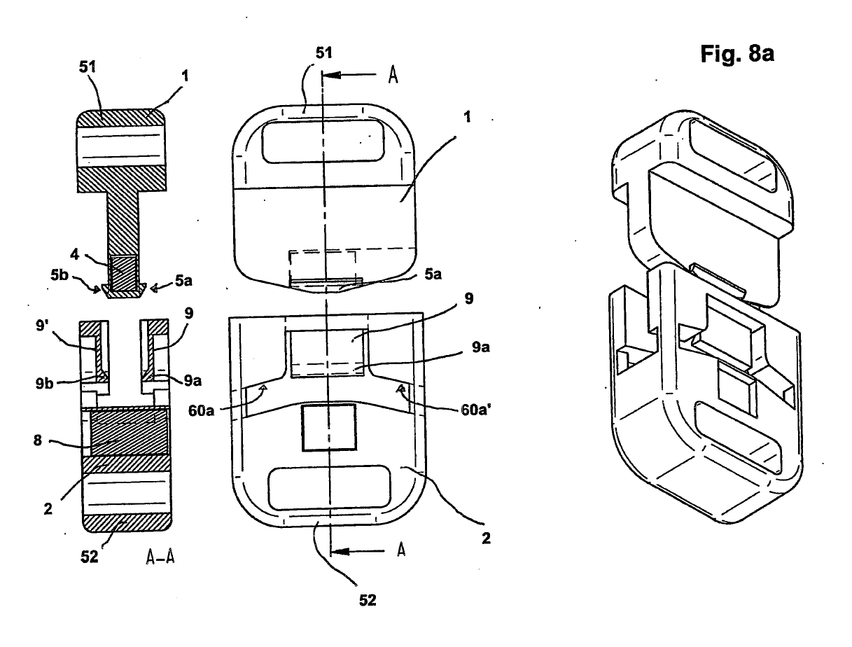

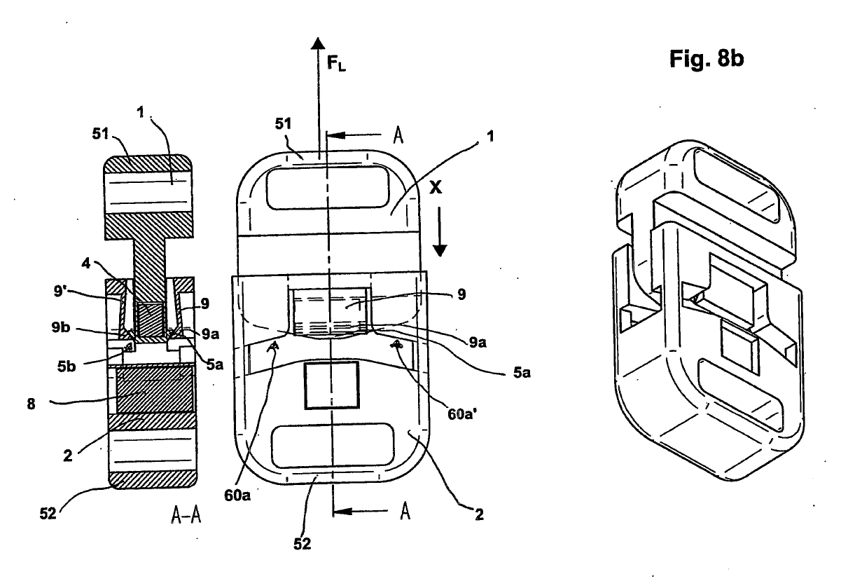

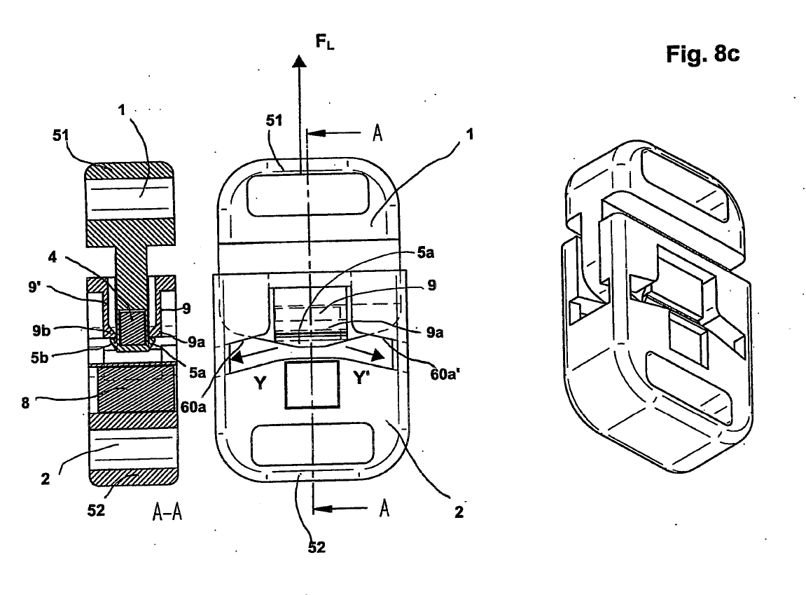

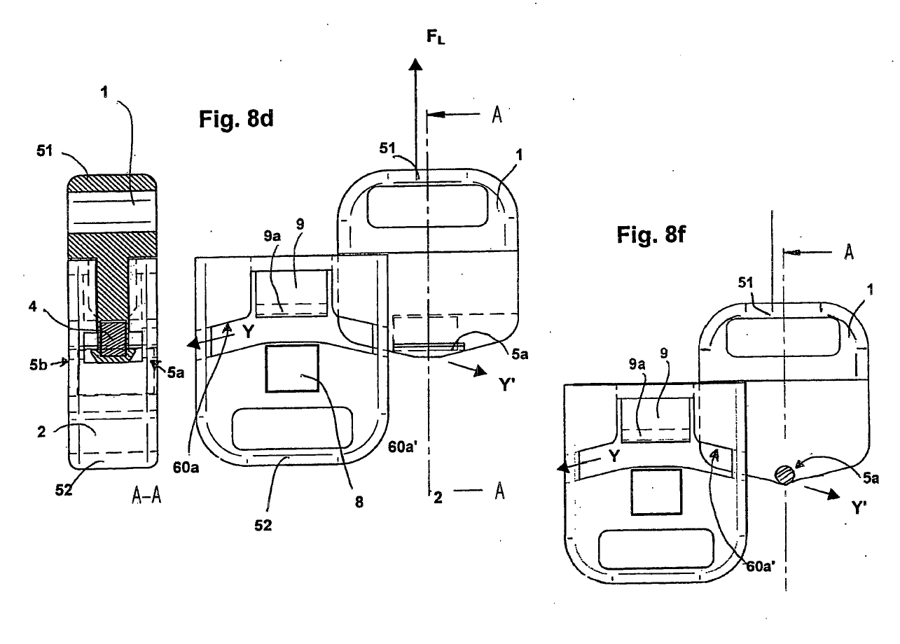

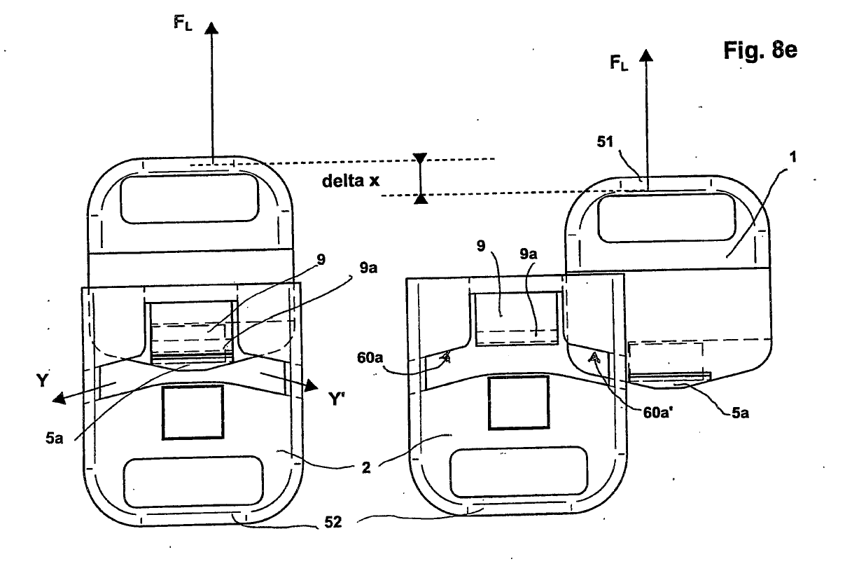

According to claim 3, the movement track is disposed at an angle, so that when shifting the connecting modules from the closed position into the open position the load housings move towards each other by an amount Δx against the load F_{L}, as is shown in FIG. 1a-e, FIG. 5a-d, FIG. 6a-g, FIG. 7, FIG. 8a-f.

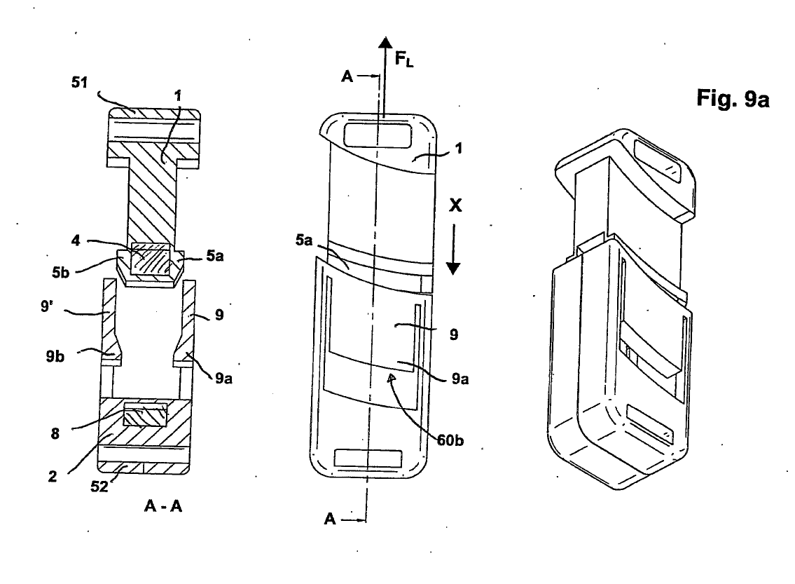

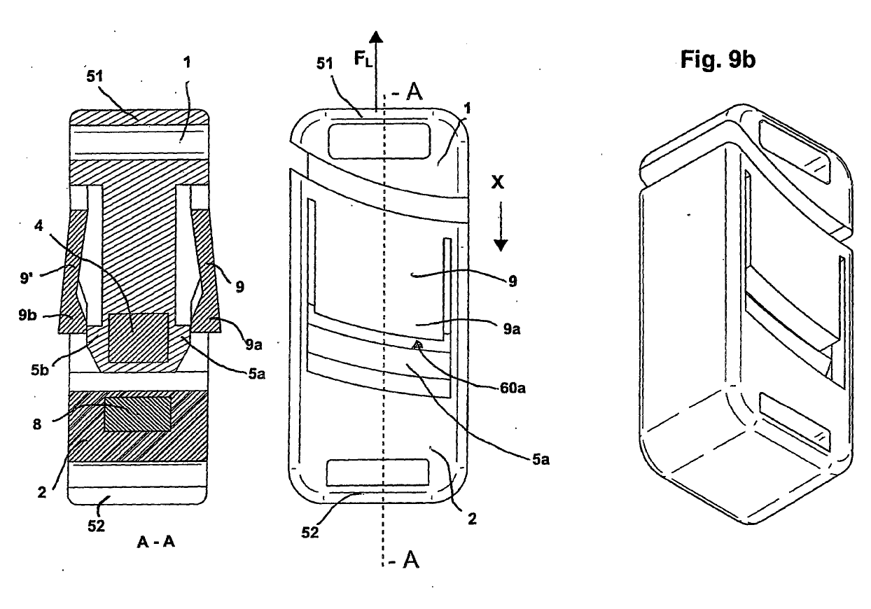

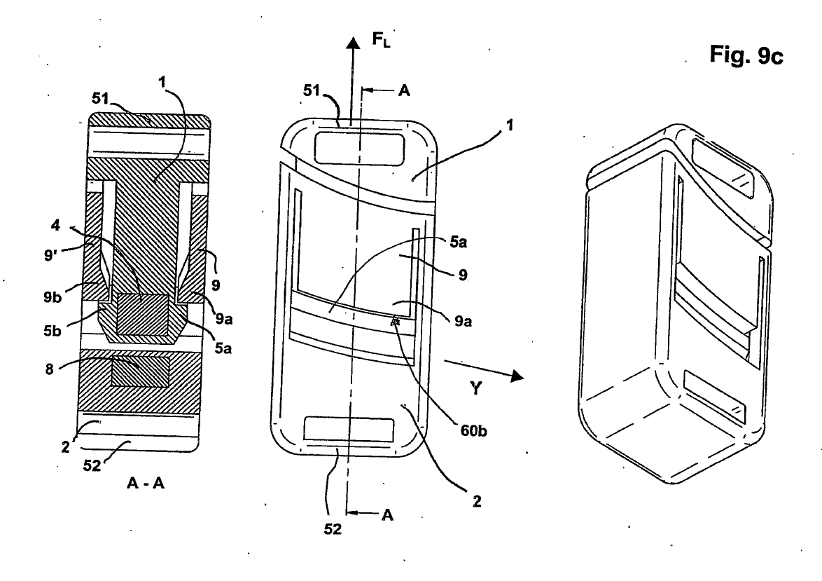

According to claim 4, the movement track (60b) is curved in the shape of a circular arc and has exactly one open position, wherein the center (M) of this circularly curved movement track is laterally shifted from the connecting line between the load housings towards the side of the open position of the movement track, so that on shifting the connecting modules from the closed position into the open position the load housings move towards each other by an amount Δx against the load F_{L}, as is shown in FIG. 9a-e.

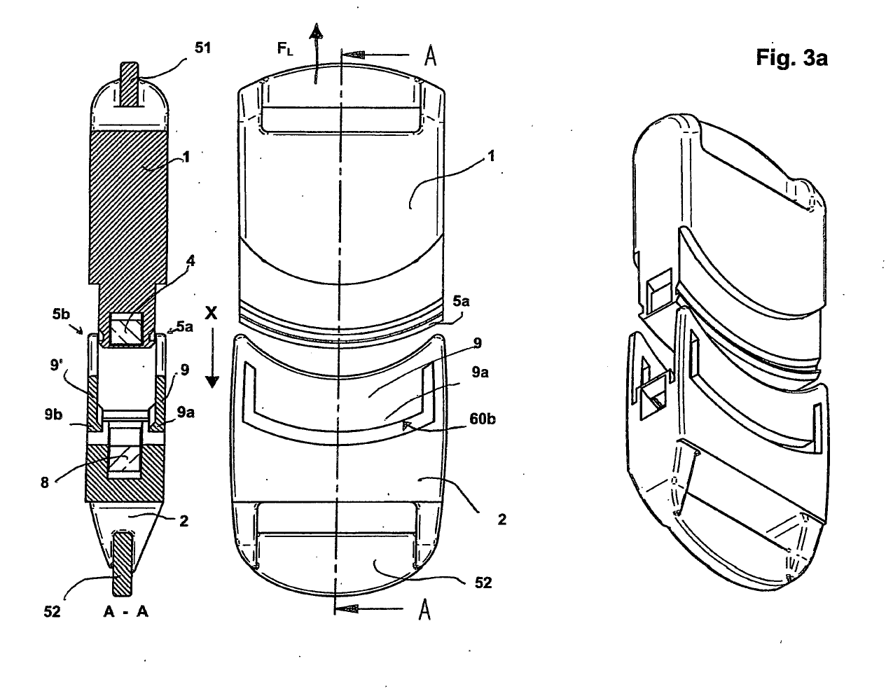

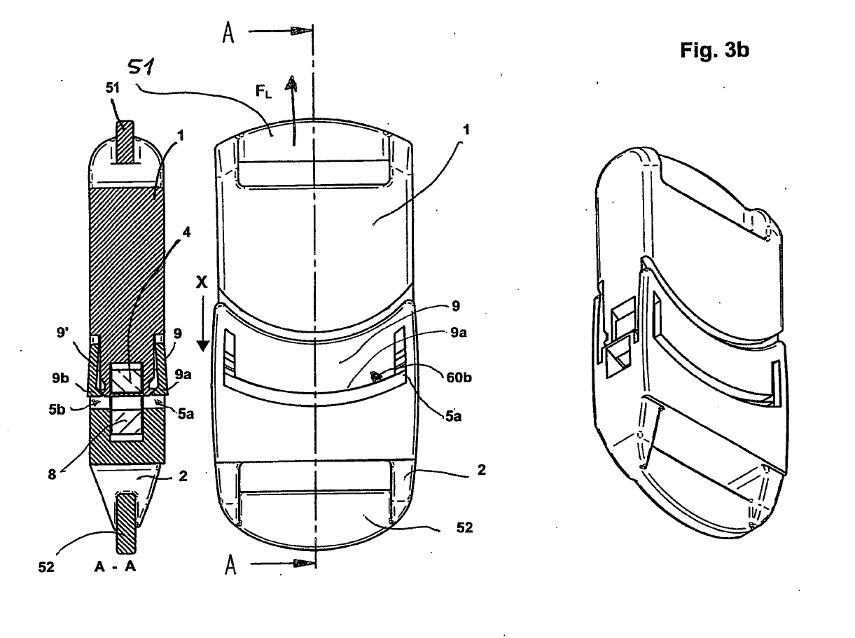

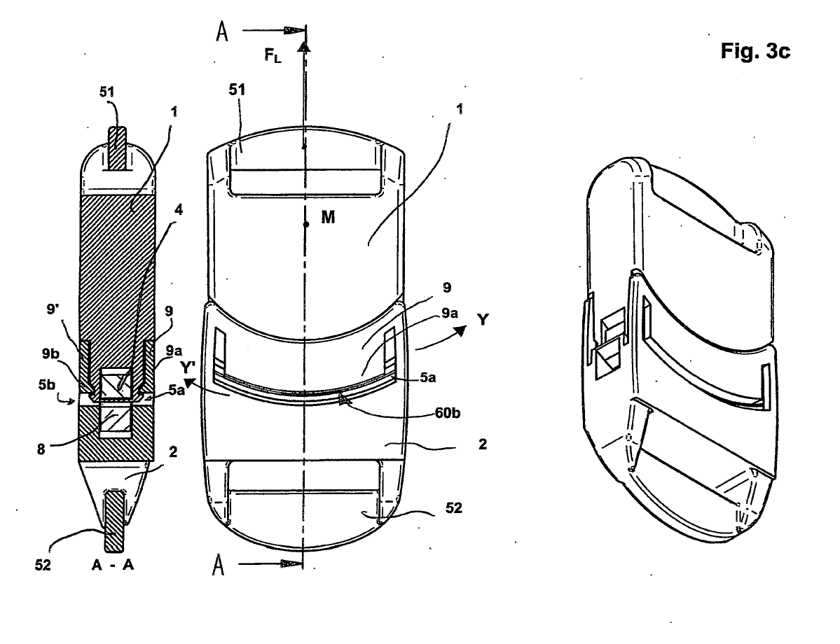

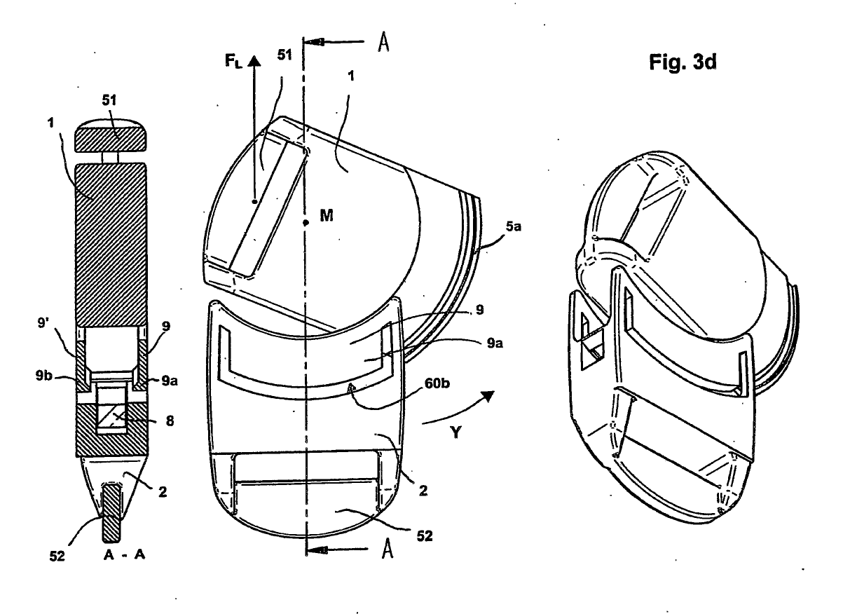

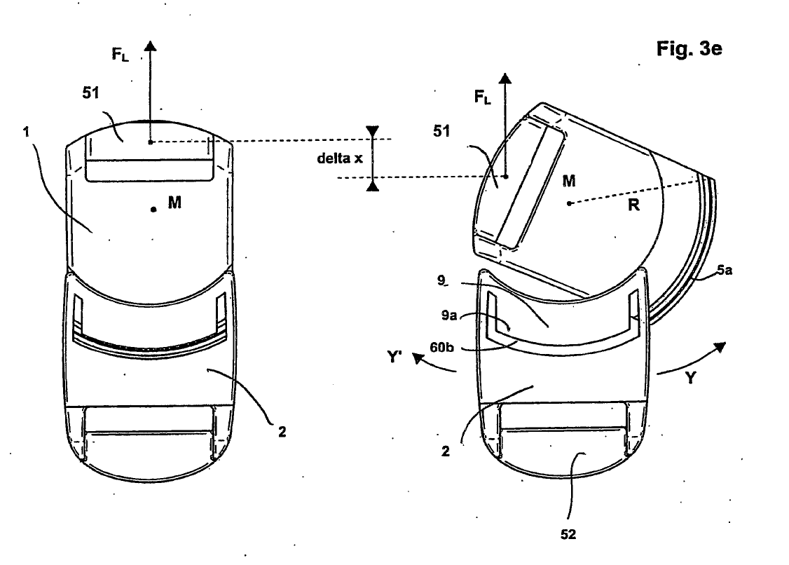

According to claim 5, the movement track (60b) likewise is curved in the shape of a circular arc, wherein the load housing (51) in the connecting module 1 lies above the center (M) of the movement track and the center (M) lies on the connecting line between the load housings, so that on shifting the connecting modules from the closed position into the open position the load housings move towards each other by an amount Δx against the load F_{L}, as is shown in FIG. 3a-e.

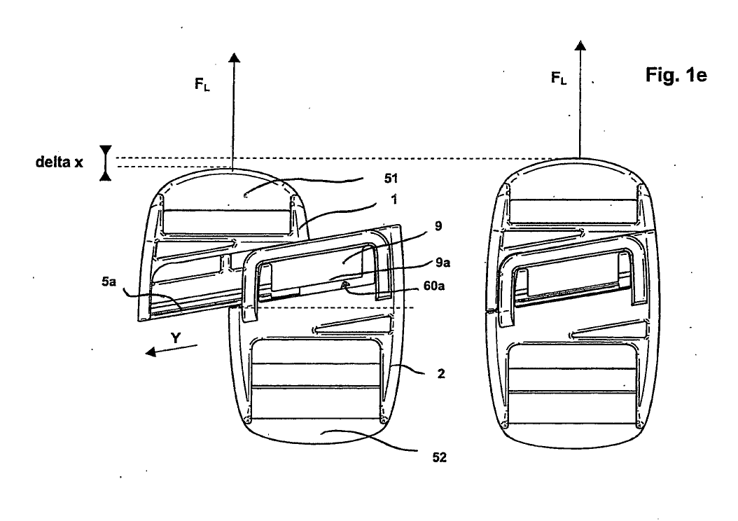

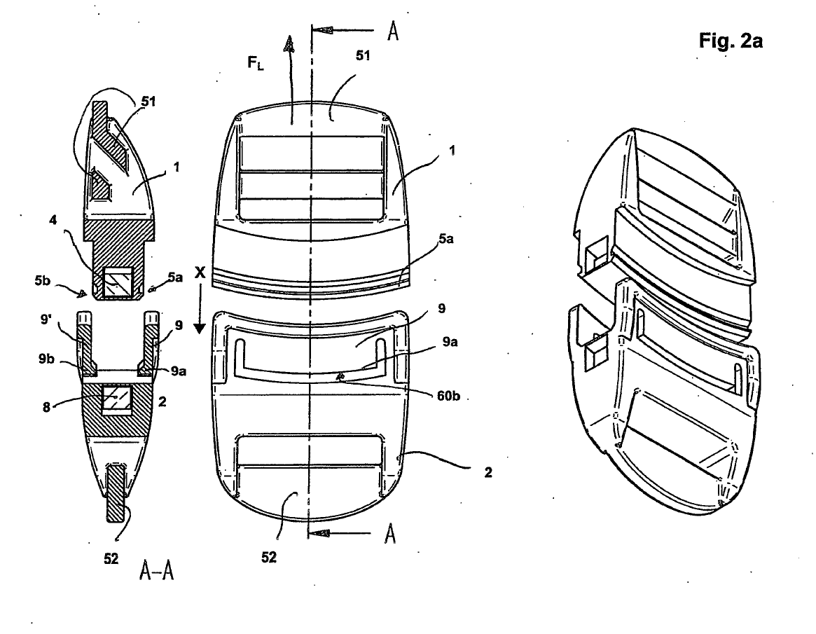

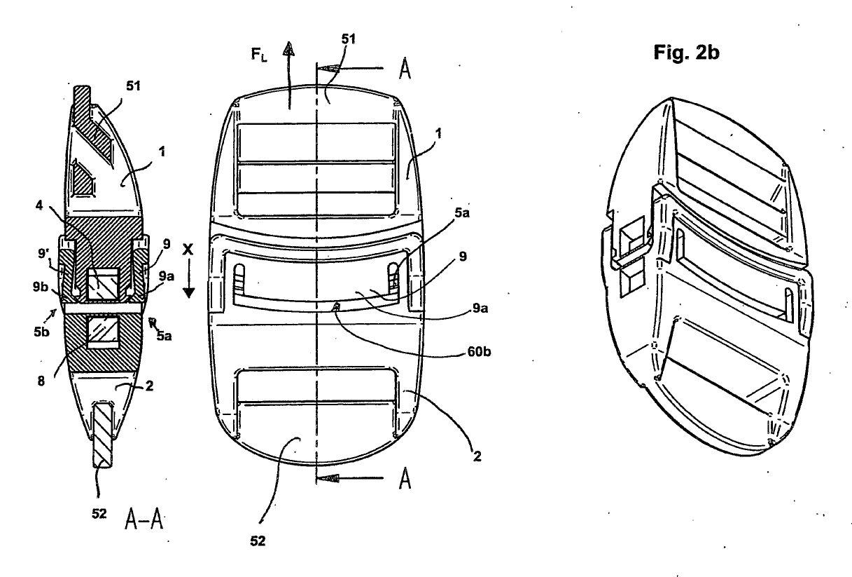

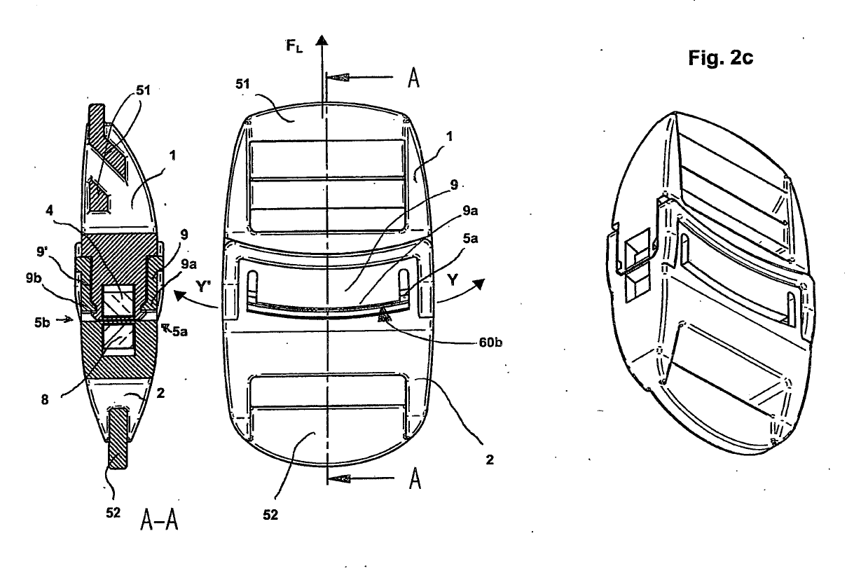

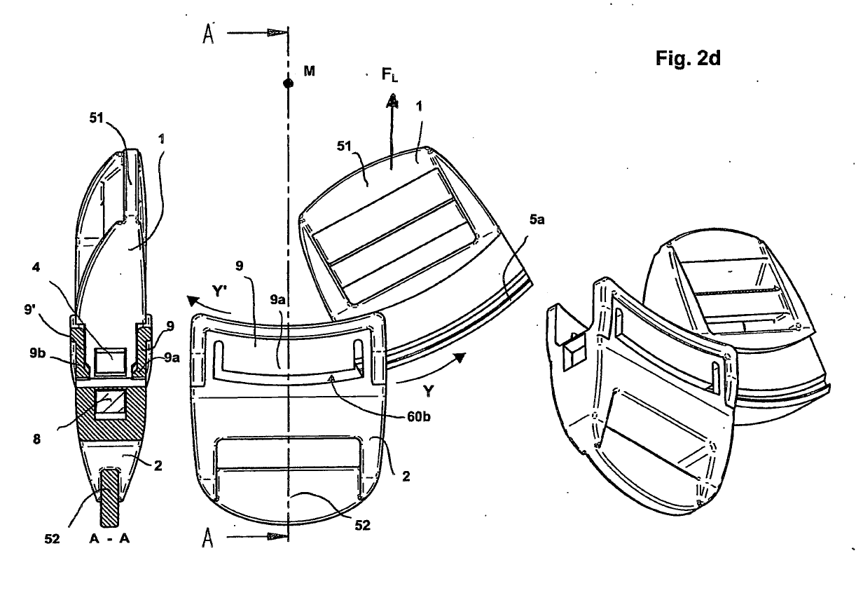

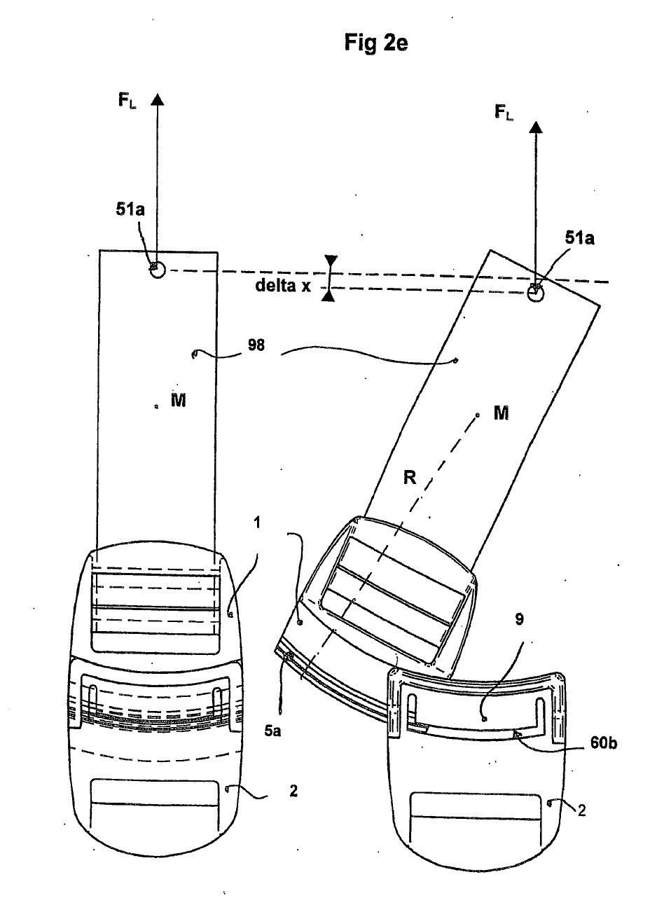

According to claim 6, the movement track has a closed position in the center and two open positions to the right and left thereof, i.e. the locking piece can be shifted from a center position to the left or to the right into one of the two open positions, as is shown in FIGS. 2a-e, 3a-e, 4 and 8a-f.

According to claim 7, the movement track (60b) is curved in the shape of a circular arc, wherein the load housing (51) in the connecting module 1 lies below the center of the curvature, the center (M) lies on the connecting line between the load housings, and to the load housing (51) a rigid extension (98) is attached, whose loaded end (51a) lies above the center of the curvature, so that on shifting the connecting modules from the closed position into the open position the loaded end (51a) and the load housing (52) move towards each other by an amount Δx against the load F_{L}, as is shown in FIG. 2e.

According to claim 8, the locking piece and the movement track are of such a shape and size that the locking piece is guided while being shifted on the movement track, i.e. a locking piece with inclined portions is forcibly guided on an inclined movement track or a locking piece with circular-arc-shaped portions likewise is forcibly guided on a circular-arc-shaped track, as is shown in FIGS. 1a-e, 2a-e, 3a-e, 4, 5a-d, 6a-e.

According to claim 9, the locking piece and the movement track are of such a shape and size that the connecting module 1 and the connecting module 2 can be swiveled against each other, as is shown in FIG. 8a-f.

According to claim 10, the movement track is repeatedly curved or angled in a meandrous manner, so that on shifting the connecting modules from the closed position into the open position the load housings (51, 52) repeatedly move towards each other and back again by an amount Δx against the load F_{L}.

According to claim 11, the surfaces of the locking piece and of the movement track, which lie on each other under load, have an increased friction due to roughened portions or toothings, so that on shifting the connecting modules from the closed position into the open position under the load F_{L} an increased force is required.

According to claim 12, the magnets and the armature or the second magnet are arranged and sized, i.e. dimensioned, such that the magnetic force automatically pulls the locking means together, unless a load F_{L} acts when snapping into place.

According to claim 13, the magnets and the armature or second magnet are arranged with an offset such that in the closed position the magnetic force produces a restoring force, which effects an automatic return of the connecting module 1 into the closed position.

The invention will subsequently be explained in detail with reference to schematic drawings and construction drawings.

FIGS. 1a-e each show a top view, a sectional view A-A and a perspective view of a linear push-in/sliding buckle of the invention for belt webbings according to claims 1 and 3 in the most important phases of movement during opening and closing. According to claim 3, the movement track is formed at an angle. The load housings 51, 52 here are formed for accommodating belt webbings and subsequently are referred to as belt webbing receptacles 51, 52. In this one and in the following embodiment, further features also are renamed depending on the embodiment, but are provided with the same reference numeral, if this is conducive to the understanding of the embodiment.

FIG. 1a shows a linear push-in/sliding buckle comprising plug 1 and housing 2 with the belt webbing receptacles 51 and 52, wherein plug and housing oppose each other separately. Now, they are put together in direction X against the force F_{L}, which in use acts in the direction of the connecting line between the belt webbing receptacles. In the Figure, this connecting line is identical with the cutting line A-A. In the plug a magnet 4 is provided, and in the housing an armature or second magnet 8 is provided. Due to the magnetic attraction, plug 1 and housing 2 are pulled together in direction X, and the magnetic force hence supports the closing under load. Locking pieces 5a, 5b arranged on the plug and spring locking elements 9, 9′ arranged on the housing together form a snap-action closure.

FIG. 1b shows the linear push-in/sliding buckle when snapping into place. The latching noses 9a, 9b of the spring locking elements are pushed to the side by the locking pieces against the spring force of the spring locking elements, until they snap into place.

FIG. 1c shows the linear push-in/sliding buckle after snapping into the closed position. Next, the plug 1 is shifted for opening relative to the housing 2 on an inclined movement track 60a in an opening direction Y. The inclined movement track 60a is disposed obliquely at an angle alpha with respect to the horizontal H (vertical to the load F_{L}), in other words: the angle between load F_{L} and opening direction Y is greater than 90°.

FIG. 1d and FIG. 1e show the linear push-in/sliding buckle after being shifted into the open position. By shifting, three functions have been effected:
Magnet 4 and armature or second magnet 8 gradually were sheared off from each other, whereby a pleasant haptics is achieved, which subjectively hardly requires force.
The locking pieces 5a, 5b and the spring locking elements 9, 9′ were laterally shifted against each other such that they came out of engagement, without the spring locking element 9, 9′ having been pushed to the side, i.e. the snap-action closure has been opened without additional effort.
In accordance with the invention, the connecting module 1 was shifted on the inclined movement track 60a such that it was pulled against the load F_{L} by an amount delta x. For this purpose, a force depending on the load was required, i.e. the linear push-in/sliding buckle is harder to open under load than without load. The greater the angle alpha, the harder is the linear push-in/sliding buckle to open under load. Thus, different variations are conceivable: in a linear push-in/sliding buckle for use on rucksacks etc. the angle alpha=about 10°-20° will be sufficient for securing the buckle under load. The angle alpha can be chosen much greater for use with safety equipment.

In FIG. 7 a development of the linear push-in/sliding buckle is shown.

FIGS. 2a-e each show a top view, a sectional view A-A and a perspective view of an arc-shaped push-in/swivel buckle for belt webbings in the most important phases of movement during opening and closing according to claims 1, 6 and 7:

FIG. 2a shows the separate arc-shaped push-in/swivel buckle to be opened on both sides, comprising plug 1 and housing 2 with the belt webbing receptacles 51 and 52, wherein plug and housing oppose each other separately. Now, they are put together against the force F_{L}, which in use acts in the direction of the connecting line between the belt webbing receptacles. In the Figure, this connecting line is identical with the cutting line A-A. In the plug a magnet 4 is provided, and in the housing an armature or second magnet 8 is provided. Due to the magnetic attraction, plug 1 and housing 2 are pulled together in direction X, the magnetic force hence supports the closing under load. Locking pieces 5a, 5b mounted on the plug and spring locking elements 9, 9′ mounted on the housing together form a snap-action closure.

FIG. 2b shows the arc-shaped push-in/swivel buckle while snapping into place. The latching noses 9a, 9b of the spring locking elements are pushed to the side by the locking pieces against the spring force of the spring locking elements, until they snap into place.

FIG. 2c shows the arc-shaped push-in/swivel buckle after snapping into the closed position. Next, the plug 1 is shifted for opening relative to the housing 2 on a circular-arc-shaped movement track 60b in an opening direction Y. In this embodiment, the movement track according to claim 6 has two open positions, which are obtained by shifting in direction Y or Y′.

FIG. 2d shows the arc-shaped push-in/swivel buckle after shifting into the open position. By shifting, three functions have been effected:
Magnet 4 and armature or second magnet 8 gradually were sheared off from each other, whereby a pleasant haptics is achieved, which subjectively hardly requires force.
The locking pieces 5a, 5b and the spring locking elements 9, 9′ were laterally shifted such that they came out of engagement, without the spring locking element 9, 9′ having been pushed to the side, i.e. the snap-action closure has been opened without additional effort.
According to claim 7 a belt webbing 98 is mounted on the plug and belt webbing and plug have been regarded as a rigid structural unit, which can be assumed in commonly used modern tightly woven belt webbings made of plastics. In this embodiment according to claim 7, the center of the circular-arc-shaped movement track 60b lies outside the plug 1 and on the connecting line between the load housings. The belt webbing 98 must have a length greater than the radius of the movement track, so that the loaded end 51a lies above the center M.

FIG. 2e shows how the plug 1 was shifted on the circular-arc-shaped movement track 60b such that the loaded end 51a of the belt webbing 98 was pulled against the load F_{L} by an amount delta x. For shifting in direction Y, a force dependent on the load was required, i.e. the arc-shaped push-in/swivel buckle is harder to open under load than without load, if the length of the belt webbing and the radius of the movement track were chosen correspondingly.

FIG. 2e shows this delta x in a comparison of the closed position and the open position.

FIGS. 3a-e each show a top view, a sectional view A-A and a perspective view of a further inventive embodiment of an arc-shaped push-in/swivel buckle for belt webbings in the most important phases of movement during opening and closing according to claims 1, 5, 6:

FIG. 3a shows the open arc-shaped push-in/swivel buckle, comprising plug 1 and housing 2 with the belt webbing receptacles 51 and 52, wherein plug and housing oppose each other separately. Now, they are put together in direction X against the force F_{L}, which in use acts in direction of the connecting line between the belt webbing receptacles. In this Figure, this connecting line is identical with the cutting line A-A. In the plug a magnet 4 is provided, and in the housing an armature or a second magnet 8 is provided. Due to the magnetic attraction, plug 1 and housing 2 are pulled together in direction X, and the magnetic force hence supports the closing under load.

Locking pieces 5a, 5b mounted on the plug and spring locking elements 9, 9′ mounted on the housing together form a snap-action closure.

FIG. 3b shows the arc-shaped push-in/swivel buckle while snapping into place. The latching noses 9a, 9b of the spring locking elements are pushed to the side by the locking pieces against the spring force of the spring locking elements, until they snap into place.

FIG. 3c shows the arc-shaped push-in/swivel buckle after snapping into the closed position. Next, the plug 1 is shifted for opening relative to the housing 2 on the circular-arc-shaped movement track 60b in an opening direction Y. In this embodiment, the movement track according to claim 6 has two open positions, which are obtained by shifting in direction Y or Y′.

FIG. 3d and FIG. 3e show the arc-shaped push-in/swivel buckle after shifting into the open position. By shifting, three functions have been effected:
Magnet 4 and armature or second magnet 8 gradually were sheared off from each other, whereby a pleasant haptics is achieved, which subjectively hardly requires force.
The locking pieces 5a, 5b and the spring locking elements 9, 9′ were laterally shifted such that they came out of engagement, without the spring locking element 9, 9′ having been pushed to the side, i.e. the snap-action closure has been opened without additional effort.
The plug 1 has been shifted on the circular-arc-shaped movement track 60b such that the belt webbing receptacle 51 was pulled against the load F_{L} by an amount delta x. According to claim 5, the center M of the movement track 60b lies inside the plug 1 in this embodiment, the center (M) lies on the connecting line between the load housings, and the belt webbing receptacle 51 lies above the center M. For shifting the belt webbing receptacle 51 by delta x, a force dependent on the load F_{L} was required, i.e. the arc-shaped push-in/sliding buckle is harder to open under load than without load.

FIG. 3e shows the delta x in a comparison of the closed position and the open position.

Depending on how strongly the arc-shaped push-in/swivel buckle should be secured under load, the radius of the movement track 60b and the distance of the belt webbing receptacle 51 from the center M should be chosen correspondingly.

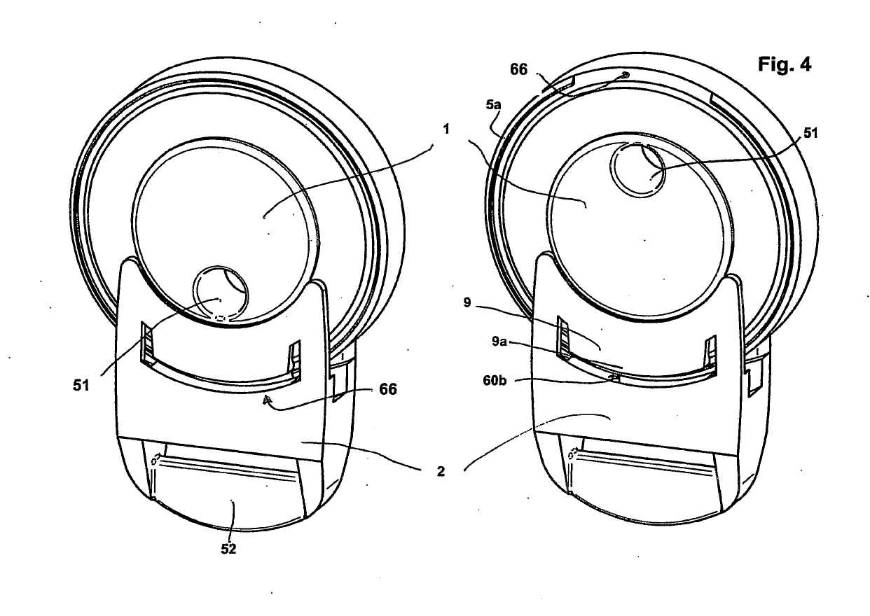

FIG. 4 shows a development of the invention according to FIG. 3a-e. Here, the release of the locking piece is effected only very late, although magnet 4 and armature 8 have already been sheared off from each other. In the present embodiment, the release is effected only after a rotation by 180°. The locking piece is formed all around and only interrupted by the release gap 66. With a rotation by about 180′, opening by the inverted magnet 4 in the plug 1 can be supported by a suitable arrangement of the magnets.

FIG. 5a-d shows a linear push-in/sliding buckle with opening by the force-deflecting surface according to claim 2. It differs from the embodiment according to FIG. 1a-e only by the different opening according to the generic parts of claims 1 and 2. Therefore, only the opening different from FIG. 1 will be discussed.

On the plug, the force-deflecting beveled surfaces 70a, 70b are arranged, and on the spring locking elements of the housing 2 the force-deflecting beveled surfaces 71a, 71b are arranged. In functional terms, the force-deflecting surfaces 71a, 71b are not absolutely necessary, but they improve the function.

FIG. 5a shows a top view and a sectional view A-A of a linear push-in/sliding buckle consisting of plug 1 and housing 2 in a separate position.

FIG. 5b shows the plug and FIG. 5d shows the housing each in different views for a better understanding of the position of the force-deflecting beveled surfaces 70a,b and 71a,b.

FIG. 5c shows the opening different from FIG. 1c: Due to the force-deflecting surfaces 70a,b 71a,b the spring locking element is gradually pushed to the side during the displacement of the plug from the closed position into the open position in direction Y, i.e. as compared to the version of FIG. 1 a certain additional effort is required, in order to release the linear push-in/sliding buckle. This is advantageous when opening the linear push-in/sliding buckle should be rendered more difficult, i.e. in safety applications.

FIGS. 6a-6g show a frontal sliding buckle, which in contrast to FIG. 1 closes vertical to the load F_{L} in direction X according to claims 1 and 3. FIGS. 6f and 6g show an exploded representation from below and from above.

In the plug 1 a magnet 4 is arranged. It is concealed by a decorative cap 62. On the plug, a locking piece 5a is arranged as a beveled edge extending around a cylinder 65, which forms a snap-action closure with a spring washer 9 arranged in the housing. On the plug, a belt webbing receptacle 52 is arranged. In the housing 2, the spring washer 9 is arranged with a circumferential latching nose 9a. It is held centered in the housing with an inner stop 63 of an end cap 61. On the housing, a belt webbing receptacle 51 is provided. Via an inclined movement track 60a, which is obliquely directed at an angle alpha with respect to the horizontal H, wherein the horizontal is vertical to a load F_{L} which in use is applied vertically between the belt webbing receptacles 51, 52, plug and housing are obliquely shifted against each other.

The phases shown in FIGS. 6a-6e correspond to the phases shown in FIGS. 1a-e, and they each show a top view, a sectional view A-A and a perspective view of an inventive frontal sliding buckle for belt webbings in the most important phases of movement during opening and closing:

FIG. 6a shows a frontal sliding buckle comprising plug 1 and housing 2 with the belt webbing receptacles 51 and 52, wherein plug and housing oppose each other separately. They are now put together in direction X. In the plug a magnet 4 is provided, and in the housing an armature or a second magnet 8 is provided. Due to the magnetic attraction, plug 1 and housing 2 are pulled together in direction X, and the magnetic force hence supports the closing under load. On closing, the magnetic-force assistance is not as pronounced as in FIG. 1 because of the location of the closing direction X different from FIG. 1. The magnetic force supports closing by the restoring force of the magnets lateral to the main direction of attraction. This restoring force is weaker than the attraction in the main direction of attraction. What is, however, essential for an easy closing under load is the fact that on closing the plug and the housing need not be pulled against each other against the load F_{L} by an additional delta y as in FIG. 10a with a closure according to the prior art, so that no unnecessary force is required on closing. The locking piece 5a arranged on the plug and the spring washer 9 arranged in the housing together form a snap-action closure.

FIG. 6b shows the frontal sliding buckle when snapping into place. Magnet 4 and armature or second magnet 8 are dimensioned and arranged such that their force of attraction is sufficient to automatically pull the snap-action closure together in direction X. The spring washer 9 is spread against the spring force of the spring washer by the locking piece 5a, until the locking piece snaps into place behind the latching nose 9a.

FIG. 6c shows the frontal sliding buckle after snapping into the closed position. Next, the plug 1 is shifted for opening relative to the housing 2 on an inclined movement track 60a in opening direction Y. The inclined movement track 60a is disposed obliquely at the angle alpha with respect to the horizontal H (vertical to the load F_{L}), in other words: the angle between load F_{L} and opening direction Y is greater than 90°.

FIG. 6d and FIG. 6e show the frontal sliding buckle after being shifted in the open position. By shifting, three functions have been effected:
Magnet 4 and armature or second magnet 8 gradually were sheared off from each other, whereby a pleasant haptics is achieved, which subjectively hardly requires force.
The cylinder 65 with locking piece 5a and the spring washer 9 were laterally shifted against each other such that they have come out of engagement, i.e. the snap-action closure has been opened. In doing so, the cylinder passes through an opening 64 in the spring washer.
In accordance with the invention, the plug 1 was shifted on the inclined movement track 60a such that it was pulled against the load F_{L} by an amount delta x. For this purpose, a force dependent on the load F_{L} was required, i.e. the frontal sliding buckle is harder to open under load than without load. The greater alpha, the harder the frontal sliding buckle is to open. Thus, different variations are conceivable: in a frontal sliding buckle for use on rucksacks etc. the angle alpha=about 10°-20° will be sufficient for securing the buckle under load. The angle alpha can be chosen much greater for use on safety equipment.

FIG. 6e shows the delta x in a comparison of the closed position and the open position.

The opening 64 in the spring washer, from which the cylinder 65 moves out on opening, can be chosen differently large for different applications.
If the opening 64 is chosen of equal size with the cylinder 65, the spring washer is not spread while being shifted in direction Y, i.e. the frontal sliding buckle opens very easily.
If the opening 64 is chosen smaller than the diameter of the cylinder 65, the spring washer is spread while being shifted in direction Y, i.e. the frontal sliding buckle opens with a predetermined resistance.
If the opening 64 is chosen very small, so that the spring washer spreads further than on snapping into place according to FIG. 6b, a different opening behavior exists: The spring washer then has been spread so far that opening is also possible against the closing direction X, and an alternative opening variant exists in that the spring locking element is pushed to the side by a force-deflecting beveled surface according to claim 2.

FIG. 7 shows a sectional representation of the push-in/sliding buckle from FIG. 1a-e in the closed position. It represents a development in that the magnets 4 and 8 are mounted offset with respect to each other such that in the closed position the magnetic force produces a restoring force, which effects an automatic return of the connecting module 1 into the closed position. In addition to the inclined movement track, this prevents an inadvertent opening under load, in particular at the start of an inadvertent displacement from the closed position into the open position.

FIGS. 8a-f each show a top view, a sectional view A-A and a perspective view of an inventive arc-shaped push-in/swivel buckle for belt webbings in the most important phases of movement during opening and closing according to claims 1, 6 and 9. According to claim 6, it can be opened on both sides by shifting in direction Y or Y′ to obtain two open positions. According to claim 9, locking piece 5a and guideway 60a, 60a′ are formed such that the locking piece can swivel independent of the contour of locking piece and movement track, i.e. it is not necessarily guided in the contour of the movement track. Due to the pivotability, plug and housing can align collinearly under the load F_{L}.

FIG. 8a shows the open push-in/sliding buckle comprising plug 1 and housing 2 with the belt webbing receptacles 51 and 52, wherein plug and housing oppose each other separately. Now, they are put together in direction X against the force F_{L}, which in use acts in direction of the connecting line between the belt webbing receptacles. In this Figure, this connecting line is identical with the cutting line A-A. In the plug a magnet 4 is provided, and in the housing an armature or a second magnet 8 is provided. Due to the magnetic attraction, plug 1 and housing 2 are pulled together in direction X, the magnetic force hence supports the closing under load. Locking pieces 5a, 5b mounted on the plug and spring locking elements 9, 9′ mounted on the housing together form a snap-action closure.

FIG. 8b shows the push-in/sliding buckle when snapping into place. The latching noses 9a, 9b of the spring locking elements are pushed to the side by the locking pieces against the spring force of the spring locking elements, until they snap into place.

FIG. 8c shows the push-in/sliding buckle after snapping into the closed position. Next, the plug 1 is shifted for opening relative to the housing 2 on the inclined movement track 60′ in an opening direction Y′. In this embodiment, the movement track according to claim 6 has two open positions, which are obtained by shifting in direction Y or Y′. The closed position lies in the center therebetween.

FIG. 8d, FIG. 8e and FIG. 8f shows the arc-shaped push-in/sliding buckle after shifting in an open position. By shifting, three functions have been effected:
Magnet 4 and armature or second magnet 8 gradually were sheared off from each other, whereby a pleasant haptics is achieved, which subjectively hardly requires force.
The locking pieces 5a, 5b and the spring locking elements 9, 9′ were laterally shifted such that they came out of engagement, without the spring locking element 9, 9′ having been pushed to the side, i.e. the snap-action closure has been opened without additional effort.
The plug 1 has been shifted on the inclined movement track 60a′ such that the belt webbing receptacle 51 was pulled against the load F_{L} by am amount delta x.

According to claim 9, the locking piece 5a is movable within the inclined movement track 60a or 60a′. In other words: Plug and housing are shifted against each other, but not guided exactly against each other, so that plug and housing can be swiveled against each other independent of the shape of the locking piece and of the movement track and can align depending on the applied force. FIG. 8f shows a variant with a round locking piece, which is movable particularly well in the movement track, so that plug and housing can be swiveled against each other.

FIG. 8e shows the delta x in a comparison of the closed position and the open position.

FIGS. 9a-e each show a top view, a sectional view A-A and a perspective view of an inventive arc-shaped push-in/swivel buckle for belt webbings in the most important phases of movement during opening and closing according to claims 1 and 4. According to claim 4, the center of the circular-arc-shaped movement track 60b is shifted laterally to the side of the open position from the center position on the connecting line between the load housings 51, 52.

FIG. 9a shows the open, unilateral push-in/swivel buckle according to claims 1 and 4, comprising plug 1 and housing 2 with the belt webbing receptacles 51 and 52, wherein plug and housing face each other separately. Now, they are put together in direction X against the force F_{L}, which in use acts in direction of the connecting line between the belt webbing receptacles. In this Figure, this connecting line is identical with the cutting line A-A.

In the plug a magnet 4 is provided, and in the housing an armature or a second magnet 8 is provided. Due to the magnetic attraction, plug 1 and housing 2 are pulled together in direction X, and the magnetic force hence supports the closing under load.

Locking pieces 5a, 5b mounted on the plug and spring locking elements 9, 9′ mounted on the housing together form a snap-action closure.

FIG. 9b shows the unilateral push-in/swivel buckle when snapping into place. The latching noses 9a, 9b of the spring locking elements are pushed to the side by the locking pieces against the spring force of the spring locking elements, until they snap into place.

FIG. 9c shows the unilateral push-in/swivel buckle after snapping into the closed position. Next, the plug 1 is shifted for opening relative to the housing 2 on the circular-arc-shaped movement track 60b in an opening direction Y.

FIG. 9d and FIG. 9e shows the unilateral push-in/swivel buckle after shifting into the open position. By shifting, three functions have been effected:
Magnet 4 and armature or second magnet 8 gradually were sheared off from each other, whereby a pleasant haptics is achieved, which subjectively hardly requires force.
The locking pieces 5a, 5b and the spring locking elements 9, 9′ were laterally shifted such that they came out of engagement, without the spring locking element 9, 9′ having been pushed to the side, i.e. the snap-action closure has been opened without additional effort.
The plug 1 has been shifted on the circular-arc-shaped movement track 60b such that the belt webbing receptacle 51 was pulled against the load F_{L} by an amount delta x.

FIG. 9e shows delta x in a comparison of the closed position and the open position.

The invention has been explained both with reference to schematic diagrams and with reference to construction drawings. The construction drawings show concrete products, whose structure and function have also been explained with respect to the schematic diagrams. Due to the multitude of the described embodiments it is clear that further variations and modifications of the invention exist, which the skilled person can find without having to perform an inventive activity, due to the disclosed technical teaching and in consideration of the individual embodiments.

In particular, it is clear to the skilled person that the closure of the invention can not only be used as a buckle for belts, but can also be connected with the object to be connected by sew-on, weld-on, snap-on or otherwise attachable fastening pieces. The closure can also directly be integrated in two objects to be connected. However, the load must chiefly act in direction of the connecting line of the load housings, in order to ensure securing of the load in accordance with the technical teaching of the invention.

It is clear to the skilled person that the curved tracks are not limited to exactly circular-arc-shaped tracks.

It is furthermore clear to the skilled person that a variety of non-illustrated combinations between the sub-claims are possible on the basis of the main claims. Finally, it is also clear to the skilled person that multipole magnetic systems comprising a plurality of magnets or armatures can also be used, which after shifting from the closed position into the open position effect a mutual repulsion of the connecting modules.

1-13. (canceled)

14. A magnetomechanical connection assembly consisting of two connecting modules each including a load housing for connecting two elements, to each of which one of the connecting modules can be attached, wherein the connecting modules to be closed can be preloaded with a load F_{L} which substantially acts in direction of the connecting line between the load housings, and the connecting modules have the following features:
a locking device with
a spring locking element which is arranged in the first connecting module, and
a locking piece which is arranged in the second connecting module, for positively locking the connecting modules,
a magnet-armature construction with
a magnet which is arranged in one of the connecting modules, and
a armature or a second magnet, which is arranged in the other connecting module, and
a movement track in the first connecting module, on which the locking piece of the second connecting module can be shifted from a closed position into an open position, wherein the locking device, the magnet-armature construction and the movement track are operatively connected by the following features:
a. on opening, the connecting modules are shifted on the movement track from the closed position into the open position, wherein magnet and armature or second magnet are shifted against each other, so that a gradual attenuation of the mutual attraction occurs, and
b. on opening, the connecting modules are shifted on the movement track from the closed position into the open position, wherein the locking piece and the spring locking element are shifted against each other, until the spring locking element no longer is in engagement with the locking piece; and
on closing, the connecting modules snap into the closed position by means of the locking device, wherein the locking piece pushes the spring locking element to the side, until it snaps into place; and
c. on closing, the magnet-armature construction pulls the connecting modules towards each other, whereby the locking of the locking device is at least supported,
wherein
the position of the load housings on the connecting modules and
the position and shape of the movement track are formed such that on shifting the connecting modules from the closed position into the open position the load housings are moved towards each other by an amount Δx against the load F_{L}, so that for opening the physical work W=F_{L}×Δx is required and thus the connection assembly is harder to open under the load F_{L} than without the load F_{L}.

15. A magnetomechanical connection assembly consisting of two connecting modules each including a load housing for connecting two elements, to each of which one of the connecting modules can be attached, wherein the connecting modules to be closed can be preloaded with a load F_{L} which substantially acts in direction of the connecting line between the load housings, and the connecting modules have the following features:
a locking device with
a spring locking element which is arranged in the first connecting module, and
a locking piece which is arranged in the second connecting module, for positively locking the connecting modules,
a force-deflecting bevel which likewise is arranged in the other connecting module,
a magnet-armature construction with
a magnet which is arranged in one of the connecting modules, and
an armature or a second magnet, which is arranged in the other connecting module, and
a movement track in the first connecting module, on which the locking piece of the second connecting module can be shifted from a closed position into an open position, wherein
the locking device, the magnet-armature construction and the movement track are operatively connected by the following features:
a. on opening, the connecting modules are shifted on the movement track from the closed position into the open position, wherein magnet and armature or second magnet are shifted against each other, so that a gradual attenuation of the mutual attraction occurs, and
b. on opening, the connecting modules are shifted on the movement track from the closed position into the open position, wherein the spring locking element is pushed to the side by the force-deflecting bevel, until the spring locking element no longer is in engagement with the locking piece; and
on closing, the connecting modules snap into the closed position by means of the locking device, wherein the locking piece pushes the spring locking element to the side, until it snaps into place; and
c. on closing, the magnet-armature construction pulls the connecting modules towards each other, whereby the locking of the locking device is at least supported,
wherein
the position of the load housings on the connecting modules and
the position and shape of the movement track are formed such that on shifting the connecting modules from the closed position into the open position the load housings are moved towards each other by an amount Δx against the load F_{L}, so that for opening the physical work W=F_{L}×Δx is necessary and thus the connection assembly is harder to open under the load F_{L} than without the load F_{L}.

16. The magnetomechanical connection assembly according to claim 14, wherein the movement track is formed with an inclination, so that on shifting the connecting modules from the closed position into the open position the load housings move towards each other by an amount Δx against the load F_{L}.

17. The magnetomechanical connection assembly according to claim 14, wherein the movement track is curved in the shape of a circular arc, has exactly one open position, and the center of the circularly curved movement track is laterally shifted from the connecting line between the load housings towards the side of the open position of the movement track, so that on shifting the connecting modules from the closed position into the open position the load housings move towards each other by an amount Δx against the load F_{L}.

18. The magnetomechanical connection assembly according to claim 14, wherein the movement track is curved in the shape of a circular arc, wherein the load housing in the connecting module lies above the center of the movement track and the center lies on the connecting line between the load housings, so that on shifting the connecting modules from the closed position into the open position the load housings move towards each other by an amount Δx against the load F_{L}.

19. The magnetomechanical connection assembly according to claim 14, wherein the movement track has a closed position in the center and two open positions to the right and left thereof, i.e. the locking piece can be shifted from a center position to the left or to the right into one of the two open positions.

20. The magnetomechanical connection assembly according to claim 14, wherein the movement track is curved in the shape of a circular arc, wherein the load housing in the connecting module lies below the center of the curvature, the center lies on the connecting line between the load housings, and to the load housing a rigid extension is attached, whose loaded end lies above the center of the curvature, so that on shifting the connecting modules from the closed position into the open position the loaded end and the load housing move towards each other by an amount Δx against the load F_{L}.

21. The magnetomechanical connection assembly according to claim 14, wherein the locking piece and the movement track are formed with such a shape and size that during shifting the locking piece is guided on the movement track, i.e. a locking piece with inclined portions is forcibly guided on an inclined movement track or a locking piece with circular-arc-shaped portions likewise is forcibly guided on a circular-arc-shaped track.

22. The magnetomechanical connection assembly according to claim 14, wherein the locking piece and the movement track are formed with such a shape and size that connecting module and connecting module can be swiveled against each other.

23. The magnetomechanical connection assembly according to claim 14, wherein the movement track is repeatedly curved or angled in a meandrous manner, so that on shifting the connecting modules from the closed position into the open position the load housings repeatedly move towards each other and back again by an amount Δx against the load F_{L}.

24. The magnetomechanical connection assembly according to claim 14, wherein the surfaces of the locking piece and of the movement track, which lie on each other under load, have an increased friction due to roughened portions or toothings, so that on shifting the connecting modules from the closed position into the open position under the load F_{L} an increased force is required.

25. The magnetomechanical connection assembly according to claim 14, wherein the magnets and the armature or the second magnet are arranged and dimensioned such that the magnetic force automatically pulls the locking means together, unless a load F_{L} acts when snapping into place.

26. The magnetomechanical connection assembly according to claim 14, wherein the magnets and the armature or second magnet are arranged with an offset such that in the closed position the magnetic force produces a restoring force, which effects an automatic return of the connecting module into the closed position.

27. The magnetomechanical connection assembly according to claim 15, wherein the movement track is formed with an inclination, so that on shifting the connecting modules from the closed position into the open position the load housings move towards each other by an amount Δx against the load F_{L}.

28. The magnetomechanical connection assembly according to claim 15, wherein the movement track is curved in the shape of a circular arc, has exactly one open position, and the center of the circularly curved movement track is laterally shifted from the connecting line between the load housings towards the side of the open position of the movement track, so that on shifting the connecting modules from the closed position into the open position the load housings move towards each other by an amount Δx against the load F_{L}.

29. The magnetomechanical connection assembly according to claim 15, wherein the movement track is curved in the shape of a circular arc, wherein the load housing in the connecting module lies above the center of the movement track and the center lies on the connecting line between the load housings, so that on shifting the connecting modules from the closed position into the open position the load housings move towards each other by an amount Δx against the load F_{L}.

30. The magnetomechanical connection assembly according to claim 15, wherein the movement track has a closed position in the center and two open positions to the right and left thereof, i.e. the locking piece can be shifted from a center position to the left or to the right into one of the two open positions.

31. The magnetomechanical connection assembly according to claim 15, wherein the movement track is curved in the shape of a circular arc, wherein the load housing in the connecting module lies below the center of the curvature, the center lies on the connecting line between the load housings, and to the load housing a rigid extension is attached, whose loaded end lies above the center of the curvature, so that on shifting the connecting modules from the closed position into the open position the loaded end and the load housing move towards each other by an amount Δx against the load F_{L}.

32. The magnetomechanical connection assembly according to claim 15, wherein the locking piece and the movement track are formed with such a shape and size that during shifting the locking piece is guided on the movement track, i.e. a locking piece with inclined portions is forcibly guided on an inclined movement track or a locking piece with circular-arc-shaped portions likewise is forcibly guided on a circular-arc-shaped track.

33. The magnetomechanical connection assembly according to claim 15, wherein the locking piece and the movement track are formed with such a shape and size that connecting module and connecting module can be swiveled against each other.

34. The magnetomechanical connection assembly according to claim 15, wherein the movement track is repeatedly curved or angled in a meandrous manner, so that on shifting the connecting modules from the closed position into the open position the load housings repeatedly move towards each other and back again by an amount Δx against the load F_{L}.

35. The magnetomechanical connection assembly according to claim 15, wherein the surfaces of the locking piece and of the movement track, which lie on each other under load, have an increased friction due to roughened portions or toothings, so that on shifting the connecting modules from the closed position into the open position under the load F_{L} an increased force is required.

36. The magnetomechanical connection assembly according to claim 15, wherein the magnets and the armature or the second magnet are arranged and dimensioned such that the magnetic force automatically pulls the locking means together, unless a load F_{L} acts when snapping into place.

37. The magnetomechanical connection assembly according to claim 15, wherein the magnets and the keeper or second magnet are arranged with an offset such that in the closed position the magnetic force produces a restoring force, which effects an automatic return of the connecting module into the closed position.
